(19) United States
(12) Patent Application Publication
(10) Pub. No.: US 2016/0033383 A1
(43) Pub. Date: Feb. 4, 2016

(54) PORTABLE SENSORS FOR DETERMINATION OF LIQUID SURFACE TENSION, AND METHODS OF USES THEREOF

(71) Applicant: TRUSTEES OF BOSTON UNIVERSITY, BOSTON, MA (US)

(72) Inventors: Mark W. GRINSTAFF, Brookline, MA (US); Eric FALDE, Brookline, MA (US); Stefan YOHE, Oakland, CA (US)

(21) Appl. No.: 14/816,613

(22) Filed: Aug. 3, 2015

Related U.S. Application Data
(60) Provisional application No. 62/032,218, filed on Aug. 1, 2014.

(51) Int. Cl. G01N 13/02

(52) U.S. Cl. CPC G01N 13/02; G01N 2013/0275

(57) ABSTRACT

The present invention relates to the measurement of liquid surface tension using a small, portable sensor. More specifically, the present invention relates to a sensor on which a droplet of the sample liquid is placed and quickly either wets and changes color or remains non-wetted for several minutes. The detection range of this type of sensor is tunable to surface tensions useful for detecting surfactant levels in water, biological liquids, and other liquids, making it useful for a variety of medical, veterinary, home-care, environmental, and global health applications.

### CROSS-REFERENCE TO RELATED APPLICATIONS

This application claims benefit under 35 U.S.C. §119(e) of the U.S. Provisional Application No. 62/032,218 filed Aug. 1, 2014, the contents of which are incorporated herein by reference in their entirety.

### GOVERNMENT SUPPORT

This invention was made with Government Support under Contract No. CA149561 awarded by the National Institutes of Health. The Government has certain rights in the invention.

### FIELD OF THE INVENTION

The present invention relates generally to the field of sensors, devices and methods for determining or characterizing liquid surface tension of a sample. Methods for determining the condition, composition, or status of a sample based on its surface tension or relative surface tension are also provided herein.

### BACKGROUND

Rapid, simple, and inexpensive point-of-care (POC) medical tests remain a significant unmet need in the developing world as well as in home care settings and walk-in clinics. A wide-spread approach to point-of-care sensors is to scale down common laboratory procedures or instruments (e.g., ELISA, PCR, or SPR); all of which have proven very accurate and precise, but are limited by their cost, power requirements, time and complexity of use. Consequently, there is increasing interest and demand for more affordable and simple to use sensor paradigms such as paper microfluidics, colorimetric indicators, mobile phone-based detection, electrochemical sensors, lateral flow immunoassays, and repurposing personal glucose monitors for wider uses. Martinez et al. Anal. Chem. (2010) 82: 3-10; Mao and Huang, Lab Chip (2012) 12:1412-1416; Yetisen et al. Lab Chip (2013) 13:2210-2251; Breslauer et al. PloS One (2009) 4: e6320; Skandarajah et al. PloS One, (2014) 9: e96906; and Xiang and Lu, Nat. Chem. (2011) 3: 697-703.

Some point-of-care sensor research has attempted to employ surface tension gradients to drive flow or maintain an un-wetted state. For example, paper treated with hydrophobic patterns was previously discussed to contain liquids within small channels in diagnostics. Martinez et al. Lab Chip (2010) 10: 2499-2504; Nie et al. Lab Chip (2010) 10: 477-483. Superhydrophobic materials were also previously discussed for use in microfluidics. Xing et al. Lab Chip (2011) 11: 3642; Elsharkawy et al. Lab Chip (2014) 14: 1168-1175. Previous reports also discuss use of superhydrophobic surfaces in platforms to stabilize microliter-scale droplets for blood typing (Li et al. Colloids Surf. B (2013) 106: 176-180) and during evaporative concentration for later assays (Gentile et al. ACS Appl. Mater. Interfaces (2012) 4: 3213-3224; Ebrahimi et al. Lab Chip (2013) 13: 4248-4256), for droplet manipulation during immunogold staining (Zhang et al. Biosens. Bioelectron. (2011) 26: 3272-3277), and gene detection (Huang et al. Lab Chip (2014) 14: 2057-2062). Superhydrophobic surfaces that wet after an ion exchange (Azzaroni et al. Adv. Mater. (2007) 19:151-154; Wang et al. Langmuir (2010) 26: 12203-12208; and Feng et al. Org. Lett. (2012) 14: 1958-1961), change in pH, or UV exposure (Lee et al. Soft Matter (2012) 8: 10238; Sun et al. Mater. Chem. A (2013) 1: 3146) were also previously discussed.

Methods to measure surface tension, and methods to create and measure wettability of porous materials are also previously discussed, e.g., in U.S. Pat. No. 5,792,941 of Rye, International Application No. PCT/HU94/00009 of Boda, U.S. Pat. No. 5,789,045 of Wapner, U.S. Pat. No. 6,152,181 also of Wapner, U.S. Pat. No. 8,272,254 B2 of Dillingham, U.S. Pat. No. 1,561,285 of Sesler, U.S. Pat. No. 4,694,685 of Dick, U.S. Pat. No. 4,976,861 of Ball, U.S. Pat. No. 7,695,550 B2 of Krupenkin, U.S. Pat. No. 8,435,397 B2 of Simon, and International Pat. App. No. PCT/US2009/031984 also of Simon, International Pat. App. No. PCT/US2008/060176 of Tuteja, International Pat. App. No. PCT/US2013/050402 of Aizenberg. However, we are not aware of any reports of using the transition from non-wetted to wetted state itself as an indicator of surface tension or using such indicator in point-of-care diagnostics.

Rapid, simple, and inexpensive point-of-care (POC) medical tests remain a significant unmet need in the developing world as well as in home care settings and walk-in clinics. For POC applications, it is more desirable to have portable and inexpensive tests that use easily-collected fluid and do not require any instrument or trained medical personnel to perform the tests. Accordingly, there is a need for development of a portable and instrument-free sensor that can be used easily and reliably, e.g., for point-of-care diagnosis, at home monitoring, or aiding diagnosis in resource-limited environments.

### SUMMARY

Embodiments of various aspects described herein are based on, at least in part, inventors' development of an instrument-free surface tension sensor for use in detecting surfactant levels in a liquid sample. In particular embodiments, the inventors have created a surface tension sensor that comprises a selectively wetting layer of tunable hydrophobicity, e.g., by electrospinning poly(ε-caprolactone), or PCL, blended with a hydrophobic copolymer (e.g., but not limited to poly(glycerol monostearate-co-ε-caprolactone) or PGC-C18) to form a mesh. The selectively wetting layer can be tuned to selectively wet in the desired surface tension range. By determining the wettability of the selectively wetting layer upon contact with a liquid sample, the surface tension of the liquid sample can be determined, which can provide information about condition, composition or status of the liquid sample.

Changes in the surface tension of bodily fluids are indicative of a number of diseases or abnormal conditions. Materials with rough surfaces, such as electrospun meshes, are very sensitive to small changes in the surface tension of liquid drops upon them, and can transition from the non-wetted state to the fully wetted state in response to small changes near the material's critical surface tension. This transition from the Cassie-Baxter to Wenzel state occurs in a range known as the critical surface tension of the material identified on a Zisman plot. Using this effect, the inventors have created tunable electrospun polymeric mesh systems that can act as simple, instrument-free surface tension sensors. A color-changing, highly hydrophilic layer can be incorporated in the device to aid visualization of wetting. The inventors have designed two surface tension sensors that can indicate changes in milk fat and urinary bile acid levels. In some embodiments, they have demonstrated that a surface tension sensor can differentiate milk with low lipid levels from whole milk (45-48 mN/m) and another surface tension sensor can discriminate normal from abnormal levels of bile acids in urine (50-54 mN/m). The former is important to breastfeeding mothers and the latter is an indication of liver disease. As the readout is easily visualized with the naked eye, the surface tension sensors or devices described herein can be employed in homes or other resource-limited environments.

Accordingly, in one aspect, it is a sensor or a device to provide a portable and simple to use method to determine the surface tension of a liquid. The design of the sensor or the device can make this measurement without the need for power, expensive instruments, or cameras.

The sensor or device comprises one or more porous materials, each consisting of polymers with varying hydrophobicity and morphology, tuned to wet within a specific surface tension range. These sensors may be cut to size and affixed to a platform such as a plastic card or glass slide. For example, the sensor can contain two polymer layers where the top is sensitive to wetting a specific liquid, and a bottom layer, that when become wet, changes color due to a dye dissolving into the liquid. A kit may be assembled which also includes one or more pipettes and possibly control liquids.

In some aspects, devices for measuring the surface tension of water or biological liquids are also provided herein. The devices can be used to aid diagnosis of abnormal levels of surfactants for medical or public health reasons. Some embodiments are directed to monitoring the calorie content of breast milk as a function of the mother's food intake in order to know or to optimize the number of calories in her breast milk. In certain embodiments, a process or method of measuring the calorie content in milk either before or after feeding an infant or both, and optionally repeating this procedure such that good nutritional behavior may be adopted is provided. In other embodiments, measurements of urine surface tension are made to aid diagnosis of liver or kidney disease. Additional embodiments are directed to the detection and measurement of surfactants or microbes in drinking water, rivers, streams, lakes, or oceans. In other embodiments, measurements of droplets of blood wetting into the sensor may indicate surface tension changes or clotting abnormalities. Other aspects relate to the provision of kits for conveniently and effectively implementing the methods associated with the devices disclosed herein. These kits can be used in the home, workplace, field, or on the go.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates a side sectional view of a surface tension sensor according to one embodiment described herein. In this embodiment, the surface tension sensor comprises a selectively wetting layer 1 (e.g., in a form of mesh). The selectively wetting layer is tuned such that it cannot be wetted by a liquid drop 2 with a certain surface tension.

FIG. 2 illustrates a side sectional view of a surface tension sensor according to one embodiment described herein. In this embodiment, the surface tension sensor comprises a selectively wetting layer 1 (e.g., in a form of mesh). The selectively wetting layer is tuned such that it can be wetted with liquid 4 that is below the critical wetting surface tension for that layer.

FIG. 3 illustrates a side sectional view of a surface tension sensor according to one embodiment described herein. In this embodiment, the layered surface tension sensor comprises a selectively wetting layer 1 (e.g., in a form of mesh), and an indicator layer 3 (e.g., in a form of mesh). The selectively wetting layer is tuned such that it cannot be wetted by a liquid drop 2 with a certain surface tension.

FIG. 4 illustrates a side sectional view of a surface tension sensor according to one embodiment described herein. In this embodiment, the layered surface tension sensor comprises a selectively wetting layer 1 (e.g., in a form of mesh), and an indicator layer 3 (e.g., in a form of mesh). The selectively wetting layer is tuned such that it can be wetted with liquid 4 that is below the critical wetting surface tension for that layer. The liquid wets the selectively wetting layer and preferentially spreads within the more hydrophilic lower layer (indicator layer). The liquid 4 has a higher concentration of surfactant than in liquid 3 of FIG. 3.

FIG. 5 illustrates a portable device comprising at least one or multiple (e.g., at least two or more, including, e.g., at least two, at least three, at least four, or more) surface tension sensors according to one embodiment described herein disposed on a solid support. In one embodiment, the surface tension sensor(s) can be affixed to a card.

FIG. 6 is a depiction of exemplary polymers used to construct one or more embodiments of the surface tension sensors described herein: ε-PCL, PGC-OH and PGC-C18. The last structure shows the backbone structure of the polymers used, where R═H for PGC-OH or R═C(O)C₁₇H₃₆ for PGC-C18.

FIG. 7A is a graph showing the range of surface tension detection tunability, using very hydrophilic sensors for nearly pure water to very hydrophobic sensors for lower surface tension liquids.

FIG. 7B is a graph showing wetting behavior of some embodiments of the surface tension sensors described herein (e.g., in a form of mesh), using 3 μL droplets of propylene glycol/water mixtures. Sensor meshes with varying hydrophobicity of the selectively wetting layer wet or support propylene glycol/water mixtures of different surface tensions.

FIG. 8 is a scanning electron micrograph of an example surface tension sensor described herein. An upper layer of larger fiber diameter is layered above the more hydrophilic lower layer which contains a pH indicator dye. In one embodiment, the selectively wetting layer comprising a mesh of about 1.5±0.6 μm diameter fibers is layered above the indicator layer comprising a mesh of about 190±60 nm diameter fibers. The top layer provides selective wetting, after which the lower layer quickly wets and changes color. Scale bar is 10 μm.

FIG. 9A is a graph showing wetting behavior of sensor meshes according to one or more embodiments described herein, using 3 μL droplets of propylene glycol/water mixtures used to model milk with different levels of milk lipids. The mesh for milk measurement immediately wets with liquid at or below 45 mN/m but has apparent hydrophobicity at 48 mN/m for 4.8±0.3 min. It shows how sensitive the sensor wetting vs. non-wetting outcome is when liquid surface tension is varied in the range of surface tensions observed in normal and low caloric content breast milk. Error bars represent standard deviations (n≧5).

FIG. 9B is a time series of pictures showing detection of milk fat content. A droplet of human breast milk diluted 1:2 on left is compared to normal human breast milk on right, demonstrating wetting and color responses over 2.5 minutes. Scale bars are both 2.0 mm and droplets are 3 μL.

FIGS. 10A-10B are pictures showing the top and profile views, respectively, of 3 μL urine droplets on the sensor mesh according to one embodiment described herein. Left, a droplet of urine with normal surface tension (54 mN/m) remains non-wetted, and remains clear. Right, a droplet of urine with high deoxycholic acid (50 mN/m) wets to the indicator layer, turning the droplet purple. Scale bars are 2.0 mm. This shows that the sensor can be used to distinguish urine with high bile acid from normal urine.

FIGS. 10C-10D are graphs showing wetting behavior of sensor meshes according to one or more embodiments described herein, using 3 μL droplets of propylene glycol/water mixtures used to model urine with different levels of surfactants (e.g., bile acids). Both figures show how sensitive the sensor wetting vs. non-wetting outcome is when liquid surface tension is varied in the range of surface tensions observed in normal urine and urine with high bile acids. FIG. 10C shows that the sensor mesh for urine measurement immediately wets (0.05±0.09 min) at or below 50 mN/m but has apparent hydrophobicity for 8.3±3.6 minutes at 53 mN/m. Error bars represent standard deviations (n≧5). FIG. 10D is a histogram showing the distribution of wetting times on the sensor mesh for urine measurement with a solution with a surface tension of 53, 52, or 50 mN/m (n=6 for 52 mN/m, n=16 for 53 and 50 mN/m). The Mann-Whitney U-Test is used to compare 50 mN/m wetting times to those at 52 mN/m (p=1.3*10⁻⁴) and 53 mN/m (p=3.9*10⁻⁷), and Student's t-test to compare 52 to 53 mN/m (p=1.2*10⁻³)

FIG. 10E is a time series of pictures showing detection of bile acids content. The droplet on the left has high bile acids (50 mN/m) and wets quickly, changing color while the lower bile acid droplet on right (54 mN/m) remains unwetted and clear. Scale bars are both 2.0 mm and droplets are 3 μL.

FIG. 10F is a graph showing brightness of urine droplets over time (of the experiments shown in FIG. 10E), indicating the appearance of the purple dye color only in the urine droplet with low surface tension (e.g., a urine droplet containing high bile acid (deoxycholic acid)).

FIG. 11 is a schematic representation of synthesis of PGC-OH and PGC-C18. This scheme is similar to that described in Wolinsky et al. Macromolecules (2007) 40: 7065-7068 except that 5-benzyloxy-1,3-dioxan-2-one and ε-caprolactone monomers are polymerized at a molar ratio of 1:20 for the dopant polymers employed in the selectively wetting layer of one or more embodiments described herein, so that small changes in hydrophobicity from PCL can be achieved more reliably.

FIGS. 12A-12C are gel permeation chromatograms (GPC) of PGC-C18 and PGC-OH compared to polystyrene standards. FIG. 12A, GPC trace of PGC-C18 (1:20), calculated to have MW of 31.3 kDa and dispersity of 1.47. FIG. 12B, GPC trace of PGC-OH (1:4) calculated to have MW of 22.9 kDa and dispersity of 1.32. FIG. 12C, GPC trace of PGC-OH (1:4), calculated to have MW of 76.0 and a dispersity of 1.36.

FIGS. 13A-13B are SEM images showing top views and cross-sectional views of milk and urine sensor meshes according to some embodiments described herein. FIG. 13A shows the milk sensor, and FIG. 13B shows the urine sensor. The bottom panels of both figures are oriented with the top selectively wetting layer facing up. Scale bars are 20 μm.

FIG. 14 is an SEM image showing the top view of the water sensor mesh according to one embodiment described herein. The water sensor mesh has thicker selectively wetting layer fibers. The scale bar is 20 μm.

FIG. 15A is a distribution graph of milk surface tensions (whole milk v. skim milk).

FIG. 15B is a graph showing the resulting ROC curves, sensitivity, and specificity for different surface tension resolutions for milk measurements.

FIG. 16A is a distribution graph of urinary surface tensions (healthy urine v. urine with high bile acids).

FIG. 16B is a graph showing the resulting ROC curves for different surface tension sensor resolutions for urine measurements.

FIGS. 17A-17C show use of a surface tension sensor according to one embodiment described herein to differentiate alcohol content (as measured by alcohol by volume (ABV)). The electrospun sensor mesh comprises (i) a selectively wetting layer (also referred to as responsive wetting layer herein) comprising 50% (1:4) PGC-C18 and 50% PCL; and an indicator layer comprising 5% BCP and 5% PGC-OH (1:4) in 90% PCL. FIG. 11A is a graph showing the wetting times of alcohol mixtures from 31.0 to 31.75 mN/m and the corresponding ABV. Based on the data shown, a surface tension difference of only 0.5 mN/m (e.g., 31.25 to 31.75 mN/m) can be detected using one or more embodiments of the surface tension sensors described herein. Thus, detecting larger differences in surface tension such as 1 mN/m or larger can be readily accomplished. This shows that the sensors described herein can be used to distinguish alcohol-water mixtures, for example, even with a different of only 2% alcohol by volume (ABV). FIGS. 11B-11C are photographs of the sensors with alcohol samples of 80 and 100 proof (40 and 50% ABV, respectively) vodkas, showing that the 100 proof sample (50% ABV) wetted the sensor within 1 minute, while the 80 proof sample (40% ABV) did not wet the sensor even after 1 minute.

### DETAILED DESCRIPTION

Embodiments of various aspects described herein are based on, at least in part, inventors' development of a surface tension sensor for use in detecting surfactant levels in a liquid sample. The surface tension sensors described herein relies on the transition from non-wetted to wetted state itself as an indicator of surface tension of a liquid fluid. In some embodiments, the selectively wetting layer can be tuned to have the wetting event occur within a change of 2-4 mN/m or 2-3 mN/m or 1-2 mN/m or 0.5-1 mN/m. Such transition from non-wetted to wetted state is more sensitive when a liquid droplet is in contact with a high specific surface area and/or a high surface roughness. Accordingly, the surface tension sensors described herein are designed not only to selectively wet in the desired surface tension range, but also to have a fluid-contacting surface with a high roughness ratio for increased sensitivity of the sensor, which enables a very small sample volume (e.g., in microliters) to be used. In some embodiments, the surface tension sensors described herein have a fluid-contacting surface with a roughness ratio of at least 3 or greater. The term “roughness” or “roughness ratio” as used interchangeably herein is defined by the Cassie-Baxter equation as the true surface area divided by the projected surface area, and can be determined by any methods known in the art, e.g., surface roughness can be calculated from data measured by scanning electron microscopy (SEM) or atomic force microscopy, as described in ISO 25178. For additional information on roughness calculation and the effects of morphology, see, e.g., Tuteja et al. Proc. Natl. Acad. Sci. U.S.A. (2008) 105: 18200-18205. In some embodiments, the lower limit for roughness or roughness ratio is approximately 1.1. When the degree of roughness is too small, contact angles may need to be photographed and precisely measured in order to resolve changes. In some embodiments, the upper limit for roughness or roughness ratio can be at least 3 or higher, including, e.g., at least 4, at least 5, at least 6, at least 7, at least 8, at least 9, or higher. In some embodiments, the upper limit for roughness or roughness ratio can range from 3 to 10. When the roughness is too high, the resulting material can be mechanically weak and flexible, and it may not support liquid. Accordingly, in some embodiments, the roughness or roughness ratio of the selectively wetting later can range from about 1.1 to about 15, from about 1.1 to about 10, from about 1.5 to about 10, from about 2 to about 10, or from about 3 to about 10. To achieve this, in one aspect, the inventors have developed an electrospun polymer mesh comprising (i) a selectively wetting layer (also referred to as a responsive wetting layer) that responds to a small change in liquid surface tension to form a wetted or non-wetted material, and (ii) an hydrophilic indicator layer that reveals a color change when wetted to aid visualization. Thus, in some embodiments, the surface tension sensors do not require any complicated instrument for outcome readout. In particular embodiments, the inventors have created a surface tension sensor that comprises a selectively wetting layer of tunable hydrophobicity, e.g., by electrospinning a core polymer material (e.g., poly(caprolactone), or PCL), blended or doped with a hydrophobic polymer or copolymer (e.g., but not limited to poly(glycerol monostearate-co-ε-caprolactone) or PGC-C18) and/or with a hydrophilic polymer or copolymer (e.g., but not limited to poly(glycerol-co-ε-caprolactone) or PGC-OH) to form a mesh.

By determining the wettability of the selectively wetting layer upon contact with a liquid sample for a pre-determined period of time, the surface tension of the liquid sample can be determined. By way of example only, as milk lipids can lower the surface tension of milk (ranging between 41 mN/m (whole milk) and 47 mN/m (skim milk)), the inventors have developed a surface tension sensor with a selectively wetting layer that wets at about 45 mN/m or lower (e.g., in less than 0.5 min) but remain non-wetted at 48 mN/m (e.g., for more than 5 mins). Thus, in this example, wetting of the surface sensor in less than 0.5 min is indicative of whole milk, while no wetting observed within 5 minutes is indicative of low-fat milk. By varying the fiber diameter, pore size, and/or polymer composition of the surface tension sensors described herein (particularly, the selectively wetting layer), the surface free energy of the sensor can be altered such that the sensor can switch between wetted and non-wetted states with liquids of a specific surface tension. Accordingly, the surface tension sensors described herein can not only be used to determine surface tension of a liquid sample, but they can also provide information about condition, composition or status of the liquid sample.

Changes in the surface tension of bodily fluids are indicative of a number of diseases or abnormal conditions. Materials with rough surfaces, such as electrospun meshes, are very sensitive to small changes in the surface tension of liquid drops upon them, and can transition from the non-wetted state to the fully wetted state in response to small changes near the material's critical surface tension. This transition from the Cassie-Baxter to Wenzel state occurs in a range known as the critical surface tension of the material identified on a Zisman plot. Using this effect, the inventors have created tunable electrospun polymeric mesh systems that can act as simple, instrument-free surface tension sensors. A color-changing, highly hydrophilic layer can be incorporated in the device to aid visualization of wetting. The inventors have designed two surface tension sensors that can indicate changes in milk fat and urinary bile acid levels. In some embodiments, they have demonstrated that a surface tension sensor can differentiate milk with low lipid levels from whole milk (45-48 mN/m) and another surface tension sensor can discriminate normal from abnormal levels of bile acids in urine (50-54 mN/m). The former is important to breastfeeding mothers and the latter is an indication of liver disease. As the readout is easily visualized with the naked eye, the surface tension sensors or devices described herein can be employed in homes or other resource-limited environments. Accordingly, some aspects of the present invention relate to sensors on which a droplet of the sample liquid is placed and quickly either wets and changes color or remains non-wetted for several minutes. The detection range of this type of sensor is tunable to surface tensions useful for detecting surfactant levels in water, biological liquids, and other liquids, making it useful for a variety of medical, veterinary, home-care, environmental, and global health applications.

In one aspect, it is a sensor or a device to provide a portable and simple to use method to determine the surface tension of a liquid. The design of the sensor or the device can make this measurement without the need for power, expensive instruments, or cameras.

The sensor or device comprises one or more porous materials, each consisting of polymers with varying hydrophobicity and morphology, tuned to wet within a specific surface tension range. These sensors may be cut to size and affixed to a platform such as a plastic card or glass slide. For example, the sensor can contain two polymer layers where the top is sensitive to wetting a specific liquid, and a bottom layer, that when become wet, changes color due to a dye dissolving into the liquid. A kit may be assembled which also includes one or more pipettes and possibly control liquids.

In one aspect, provided herein is a sensor based on a roughened or porous material with one or more layers that wets (absorbs) only liquids that are only below a certain surface tension (the critical wetting surface tension of the sensor).

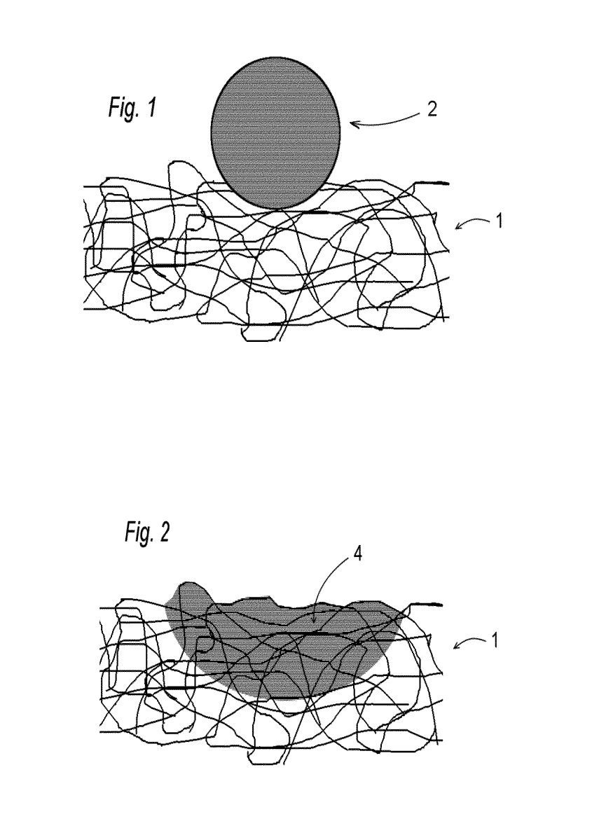

As shown in FIG. 1, a selectively wetting mesh 1 supports a droplet 2 which either remains supported for multiple minutes or a droplet 4 is quickly absorbed into the mesh 1, wetting into the mesh, as shown in FIG. 2.

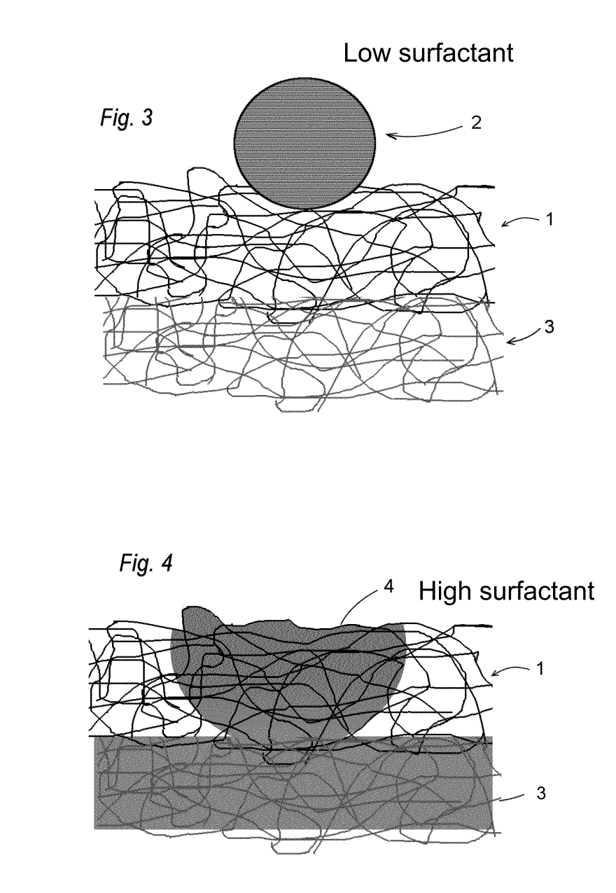

As shown in FIGS. 3-4, the mesh may also have a layered structure such that one or more lower layers 3 is more hydrophilic providing rapid wetting within the lower layer 3, once liquid wets the upper layer 1.

The sensor can comprise a material that maintains a high roughness while also supporting a liquid droplet. The material for use in the sensor can include but are not be limited to: Teflon, polystyrene, modified polystyrene, polypropylene, polyurethane, ethylene vinyl alcohol, (E/VAL), cellulose, lignocellulose, fluoroplastics, (PTFE), (FEP, PFA, CTFE, ECTFE, ETFE), fluorosilanes, polyacrylates, (Acrylic), polybutadiene, (PBD), polybutylene, (PB), polydimethylsioxane (PDMS), poly(ε-caprolactone) (PCL), poly(glycerol-co-ε-caprolactone) (PGC-OH), poly(glycerol monostearate-co-ε-caprolactone), (PGC-C18), polyethylene, (PE), polyethylenechlorinates, (PEC), polylactide, (PLA), poly(lactic-co-glycolic acid), (PLGA), poly(lactic acid-co-glycerol monostearate), (PLA-PGC18), polymethylpentene, (PMP), polypropylene, (PP), polyvinylchloride, (PVC), polyvinylidene chloride, (PVDC), acrylonitrile butadiene styrene, (ABS), Polyamide, (PA), (Nylon), polyamide-imide, (PAI), polyaryletherketone, (PAEK), (Ketone), polycarbonate, (PC), Polyektone, (PK), polyester, polyetheretherketone, (PEEK), polyetherimide, (PEI), polyethersulfone, (PES), polyimide, (PI), polyphenylene oxide, (PPO), polyphenylene sulfide, (PPS), polyphthalamide, (PTA), polysulfone, (PSU), allyl resin, (Allyl), melamine formaldehyde, (MF), phenol-formaldehyde plastic, (PF), polyester, polyimide, (PI), silicone, silicon, or silicon nitride.

The sensor can be processed in a way to create high surface roughness, including but not limited to: soft lithography, hard lithography, reactive ion etching, acid etching, salt leaching, freeze drying, spray drying, gas foaming, electrospraying, electrospinning, weaving, pressing pulp, or polyelectrolyte multilayer assembly.

The liquid to be tested can be collected from any source, including, e.g., but not limited to, water (public, lake, stream, river, commercial, purified, bottled, industrial), milk, breast milk, infant formula added to water, blood, urine, saliva, tears, cerebrospinal fluid, other bodily fluids, combinations of the above liquids, or another liquid type not explicitly listed here.

Each layer can differ in composition and/or dye content described herein, affecting different wetting properties and visual indications.

The critical wetting surface tension (CWST) of the selectively wetting layer described herein (also referred to as “sensor CWST”) is a property of the hydrophobicity of the layer supporting a liquid. The ability of the selectively wetting layer and thus the sensor to resolve CWST value within a definite range is a property of the uniformity of manufacture as well as the sensor roughness. There are multiple ways to tune the surface tension sensor CWST and resolution for the sensor.

As used herein, the term “wetting” refers to a liquid droplet that is in contact with a surface reaching an apparent contact angle of less than 90° (relative to the surface) over a pre-determined period of time. In accordance with various aspects described herein, the sensor comprises an indicator layer to facilitate visualization of the wetting event. For example, the detectable agent in the indicator layer is a soluble dye that would display its color when a liquid droplet wets the selectively wetting layer and thus the indicator layer.

As used herein, the term “sensor CWST” or “CWST” or “critical wetting surface tension” refers to the range of liquid surface tensions. The lower limit of the sensor CWST range is defined by highest surface tension of a liquid that wets within a “fast wetting” time and the upper limit of the sensor CWST range is defined by the lowest surface tension of a liquid that remains unwetted or partially wetted (e.g., exhibiting an apparent contact angle that is greater than 90°) at a longer “slow wetting” time. For example, when the “fast wetting” time is chosen as 15 seconds and the “slow wetting” is chosen as 120 seconds, and droplets of 52 mN/m do not wet until after 15 seconds on average, while droplets of 51 mN/m wet within 10 seconds on average, the sensor CWST is considered as 52-51 mN/m. Because of a metastable partially wetted state, a time component must be included (See, e.g., A. H. Ellison, W. A. Zisman, J. Phys. Chem. 58 (1954) 503-506). The term “sensor resolution” as used herein is defined as the inverse of the difference between the lower limit and upper limit of the sensor CWST range. In the aforementioned example, the sensor resolution would be 1.0 m/mN.

In some embodiments, the difference between the highest surface tension and the lowest surface tension of a sensor CWST range can be about 0.5-1 mN/m, or about 1-2 mN/m, or about 1-5 mN/m, or about 2-4 mN/m, or about 2-3 mN/m.

In some embodiments, the difference between the lower limit and upper limit of the sensor CWST range can be about 0.5 mN/m, about 1 mN/m, about 2 mN/m, about 3 mN/m, about 4 mN/m, or about 5 mN/m. In some embodiments, the difference between the lower limit and upper limit of the sensor CWST range can be about 0.5-1 mN/m, about 1-2 mN/m, or about 2-3 mN/m. In some embodiments, the difference between the lower limit and upper limit of the sensor CWST range can be about 2-4 mN/m. In some embodiments, the sensor resolution can be a value resulting from the inverse of the difference between the lower limit and upper limit of the sensor CWST range as indicated above.

The choice of times for the “fast wetting” and “slow wetting” times is dependent on an application and/or users' preference. Preferably, the “slow wetting” time is at least 1 minute or longer, including, e.g., at least 2 minutes, at least 3 minutes, at least 4 minutes, or longer. In some embodiments, the “slow wetting” time is about 1-10 minutes, or about 1-5 minutes, or about 2-8 minutes, or about 3-5 minutes. The “fast wetting” time is generally selected such that it is shorter than the “slow wetting” time and the difference between the “fast wetting” and the “slow wetting” time is large enough such that users will not mistakenly classify a wetting droplet as non-wetting even without a timer, e.g., 30 seconds or less. Accordingly, in some embodiments, the “fast wetting” time can be less than the “slow wetting time” by at least 1 minute or more, including, e.g., at least 2 minutes, at least 3 minutes, at least 4 minutes, or more. In some embodiments, the “fast wetting” time can be no more than 1 minute, no more than 45 seconds, no more than 30 seconds, no more than 15 seconds or less. More viscous or opaque liquids, or larger sample volumes may require longer times, as the wetting process will take longer. As such, the “fast wetting” time can be longer than 1 minute.

The sensors described herein rely for their function on the transition from the Cassie-Baxter partially wetted state to the Wenzel fully wetted state. The Cassie-Baxter and Wenzel equations that describe these states, respectively, each contain a roughness ratio parameter (which is, as defined earlier, the surface area wetted by the liquid (true surface area) divided by the projected surface area), and the higher this value the greater the difference in apparent contact angles between these states. See, e.g., Wenzel, R. N. Ind. Eng. Chem. (1936), 28:988-994; and Cassie, A. B. D.; Baxter, S.; Tram. Faraday Soc. (1944) 40:546-551. Accordingly, the higher the roughness or porosity of the selectively wetting layer on which the droplet is placed, the higher the surface tension resolution (referred to as sensor resolution herein) will be. While electrospinning was used to exemplify the fabrication of a roughened and/or porous selectively wetting layer described herein, other art-recognized methods, e.g., but not limited to soft lithography, hard lithography, reactive ion etching, acid etching, salt leaching, freeze drying, spray drying, gas foaming, electrospraying, weaving, embossing, pressing pulp, and/or polyelectrolyte multilayer assembly can be used to produce a selectively wetting layer with equivalent roughness and/or porosity.

An example method to determine the sensor CWST is using droplets of water or a buffered solution (e.g., a 20 mM phosphate buffer to control pH) mixed with either ethylene glycol or propylene glycol or ethanol or a mixture thereof. The surface tensions of these mixtures are well studied. For example, liquids are added to the surface tension sensor meshes and the time until the apparent contact angle reaches 90° is recorded. This is the Zisman method for determining the CWST, also called the critical wetting surface tension (A. H. Ellison, W. A. Zisman, J. Phys. Chem. 58 (1954) 503-506).

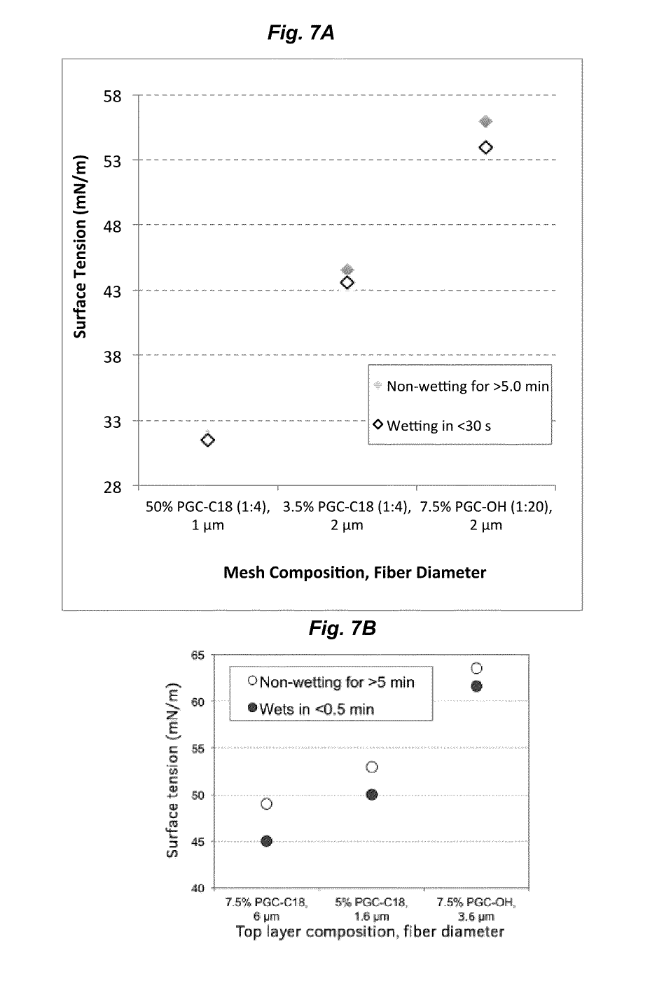

The sensor CWST can be tuned to suit the need of an application, e.g., by varying the polymer composition (e.g., hydrophilic and/or hydrophobic materials) of the selectively wetting layer. Hydrophilic materials are those which when flat and in air, water displays a low contact angle of <90° relative to the fluid-contact surface of the material. Hydrophobic materials are those upon which when flat and in air, water displays a contact angle of >90° relative to the fluid-contact surface of the material. For example, PGC-OH has a flat contact angle of 87° so it is hydrophilic, and PGC-C18 has a flat contact angle of 127° so it is hydrophobic (Wolinsky et. al. J. Control. Release. 144 (2010) 280-287). The more hydrophobic the selectively wetting layer is, the lower CWST range will be tuned to (i.e. decrease from 42-40 mN/m to 38-36 mN/m). The hydrophobicity and the CWST should follow the Cassie-Baxter equation. As shown in FIGS. 7A and 7B, a selectively wetting layer can be tuned to a lower CWST range (e.g., about 45-48 mN/m) by doping a core polymer material (e.g., PCL or polystyrene) with a hydrophobic polymer (e.g., PCG-C18) to increase the hydrophobicity of the selectively wetting layer. Similarly, a selectively wetting layer can be tuned to a higher CWST range (e.g., about 62-64 mN/m) by doping a core polymer material (e.g., PCL, PLLA, or PC) with a hydrophilic polymer (e.g., PGC-OH or polyethylene terepthalate (PET)) to increase the hydrophilicity of the selectively wetting layer. Alternatively or in addition, small molecule dopants can be added to either increase the CWST (e.g., adding hydrophilic agents such as salts, e.g. NaCl, folate, or biotin) or decrease the CWST (e.g., adding hydrophobic agents, e.g., stearic acid).

In some embodiments, the selectively wetting layer can be formed on top of an indicator layer, forming a dual-layered structure sensor. In these embodiments, the thicker the selectively wetting layer is, the lower the surface tension range, and thus the lower the sensor CWST, will be. In some embodiments, the selectively wetting layer can be thicker than 20 μm. A thicker selectively wetting layer can reduce chances of imperfections exposing the indicator layer completely. However, the selectively wetting layer should be thin enough to ensure that rapid wetting reaches the indicator layer quickly and can diffuse any dye contained therein. In some embodiments, the selectively wetting layer can have a thickness of no more than 500 μm, including, e.g., no more than 400 μm, no more than 300 μm, no more than 200 μm, no more than 100 μm.

The indicator layer need not contain the core polymer nor share any polymer in common with the selectively wetting layer. In some embodiments, the indicator layer can be composed completely of a hydrophilic polymer (e.g., but not limited to polyvinylpyrrolidone (PVP) or poly(2-hydroxyethyl methacrylate) (pHEMA)). The indicator layer should have a thickness that provides a sufficient volume to absorb liquid to allow apparent wetting. In some embodiments, the indicator layer can be at least 50 μm thick or more, including, e.g., at least 60 μm thick, at least 70 μm thick, at least 80 μm thick, at least 90 μm thick, at least 100 μm thick, or more. In some embodiments, the indicator layer can have a thickness of no more than 2 mm. Too thick the indicator layer can require excessive material.

Example 7 and Table 1 provides exemplification of how different electrospinning conditions and/or polymer compositions resulted in surface tension sensors with different ranges of sensor CWST. For example, increasing electrospinning time and/or polymer concentration generally increases the thickness of the selectively wetting layer. As noted above, a thicker selectively wetting layer leads to a lower sensor CWST. Thus, increasing electrospinning time and/or polymer concentration can result in a sensor CWST at a lower range. Similarly, decreasing electrospinning time and/or polymer concentration can decrease the thickness of the selectively wetting layer, which can in turn increase the sensor CWST range.

In some embodiments, the electrospinning time per 500 cm² area can range from about 1 minute to about 10 minutes, from about 2 minutes to about 8 minutes, from about 3 minutes to about 5 minutes. In some embodiments, the electrospinning time per 500 cm² area can range from about 1 minute to about 20 minutes, from about 4 minutes to about 10 minutes, from about 5 minutes to about 8 minutes. In one embodiment, the electrospinning time per 500 cm² area can range from about 1 minute to about 5 minutes. For example, a 160 mg/mL solution of 3.5 wt % PGC-18 (1:4) and 96.5 wt % PCL pumped at 3 mL/hr results in a sensor with the selectively wetting layer electrospun for 8 minutes (over 500 cm²) has a CWST of 46.5-46.0 mN/m, while electrospinning the same solution at the same parameters for 10 minutes will result in a sensor with a CWST of 45.5-45.0 mN/m.

In some embodiments, the total polymer concentration of the selectively wetting layer can range from about 100 mg/mL to about 200 mg/mL, or from about 125 mg/mL to about 175 mg/mL. For example, electrospinning a solution of 200 mg/mL of 10% PGC-OH (1:20) and 90% PCL at 10 mL/hr results in fibers of 5.0±0.7 μm while a 175 mg/mL solution of the same composition and flow rate results in fibers of 3.9±0.7 μm.

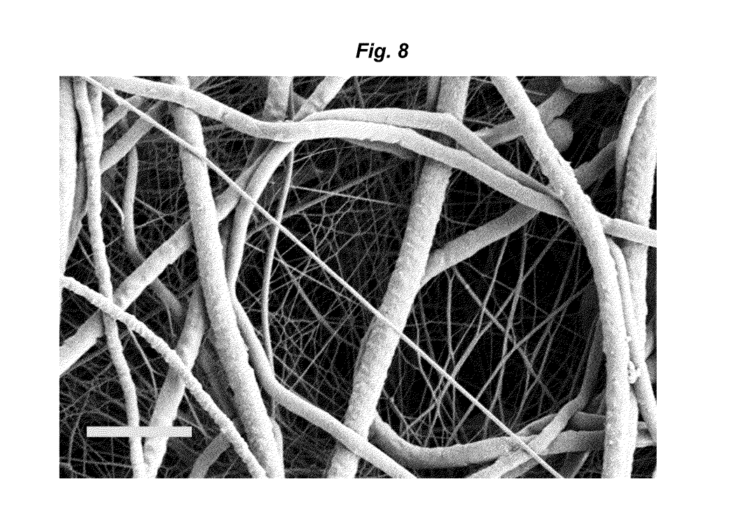

Decreasing polymer solution flow rate or polymer solution viscosity (e.g., by changing solvent or decreasing polymer concentration) can decrease the diameter of electrospun fibers, which in turn increases the porosity of the resulting mesh and thus increases the sensor resolution. For example, by decreasing the diameter of electrospun fibers from 5 μm to 1 μm, the sensor CWST range can reduce from 42-40 mN/m to 41.25-40.75 mN/m, which provides a higher sensor resolution. In some embodiments, the fiber diameter in the selectively wetting layer and the indicator layer can independently range from about 1 μm to about 10 μm, or from about 1.5 μm to about 9 μm, or from about 2 μm to about 8 μm, or from about 3 μm to about 6 μm. In some embodiments, the fibers in the selectively wetting layer and the indicator layer can have the same or comparable fiber diameters. In some embodiments, the fibers in the selectively wetting layer and the indicator layer can have different fiber diameters. For example, as shown in FIG. 8, the selectively wetting layer can have larger fibers than in the indicator layer.

In some embodiments, the selectively wetting layer can have fibers of at least about 100 nm in diameter or higher, including, e.g., at least about 200 nm, at least about 300 nm, at least about 400 nm, at least about 500 nm, or higher. Selectively wetting layers with too small diameter fibers would not be able to support the partially wetted state, but the fiber diameters should be small enough to provide the desired roughness of the selectively wetting layer. In some embodiments, the selectively wetting layer can have fibers that are smaller than 50 μm or less, including, e.g., smaller than 40 μm, smaller than 30 μm, smaller than 20 μm, smaller than 10 μm or less, in order to provide high roughness.

The indicator layer can contain fibers of any size. For example, the fibers in the indicator layer can have a smaller diameter, e.g., as small as 20 nm, as they do not need to support the partially wetted state, and the sensor can function even if these fibers dissolved after being wetting. The fibers in the indicator layer can also be as large as 1 mm.

To make fibers of different diameters, the polymer solution flow rate for electrospinning can range from about 1 mL/hr to about 15 mL/hr, or about 3 mL/hr to about 10 mL/hr, or about 5.0 mL/hr to about 7.5 mL/hr.

Increasing the proportion of a hydrophobic polymer or additive will decrease the CWST, while increasing the amount of a hydrophilic polymer or additive will increase the CWST.

Increasing the applied voltage during electrospinning can result in multi-jetting, which can decrease the fiber diameter and increase the sensor resolution. In some embodiments, the applied voltage can have a range of about 10-25 kV or about 13-20 kV, or about 13-18 kV. In some embodiments, the applied voltage can have a range of about 5-10 kV or about 10-15 kV, or about 15-25 kV. There are not significantly different voltages required in the manufacture of high vs. low CWST sensors, but voltage is instead related to the flow rate and solution viscosity. See, e.g. Lee, et. al., Langmuir. 29 (2013) 13630-13639.

Further increasing the voltage and/or decreasing the solution concentration can result in the “beads on a string” morphology or electrospraying, which can either increase or decrease the sensor CWST and sensor resolution, depending on the resulting roughness of the electrospun mesh.

In some embodiments, the electrospun fibers can have a smooth surface. In some embodiments, the electrospun fibers can have rough surface. In these embodiments, the surface tension sensors described herein can be characterized by a “dual-scale roughness”—microscopic roughness (e.g., the random or uniform arrangement of the fibers to form a selectively wetting layer provide a roughened or porous substrate) and a nanoscopic roughness (e.g., depending on the individual fiber surface). For example, to induce roughness on fiber surface, electrospinning can be performed with a smaller needle-to-target distance (e.g., about 3-10 cm) and/or higher humidity (e.g., about 90% relative humidity). As noted herein, the wetting of materials with high surface roughness is especially sensitive to the surface tension of liquids with which they are in contact, a “dual-scale roughness” can further increase the sensor resolution.

Accordingly, a sensor can be tuned to any specific critical wetting surface tension (CWST) within a specific range, e.g., by varying different parameters as described above. In some embodiments, the CWST can be between 25 and 30 mN/m. In some embodiments, the CWST can be between 30 and 35 mN/m. In some embodiments, the CWST can be between 35 and 40 mN/m. In some embodiments, the CWST can be between 40 and 45 mN/m. In some embodiments, the CWST can be between 45 and 50 mN/m. In some embodiments, the CWST can be between 50 and 55 mN/m. In some embodiments, the CWST can be between 55 and 60 mN/m. In some embodiments, the CWST can be between 60 and 65 mN/m. In some embodiments, the CWST can be between 65 and 70 mN/m. In some embodiments, the CWST can be between 70 and 75 mN/m. In some embodiments, the CWST can span a range combining combinations of the above. In some embodiments, the CWST can be a sub-range of the indicated ranges above. As described above, the lower end of the CWST refers to the lowest surface tension of a liquid that wets within a “fast wetting” time defined above, and the higher end of the CWST refers to the highest surface tension of a liquid that remain unwetted or partially wetted after a longer “slow wetting” time as defined above. In one embodiment, the fast wetting time is less than 30 seconds. In one embodiment, the slow wetting time is at least 5 minutes or more.

Dyes or visual indicators can be incorporated into one or more indicator layers of the sensor. The indicator layer is configured such that it is rapidly and completely wetted by any test liquid. Thus, the indicator layer generally has a very low apparent contact angle, e.g., less than 10°. When this occurs with an aqueous test liquid, the material is often known as superhydrophilic. If the test liquid comprises or is an oil, the indicator layer is more desirable to be superoleophilic. Salts such as dyes can also provide high surface energy and therefore facilitate the function of the indicator layer, as well as providing an addition visual cue of wetting. These dyes can include but not be limited to the following: litmus, bromophenol blue, bromophenol red, cresol red, α-naphtholphthalein, methyl purple, thymol blue, methyl yellow, methyl orange, methyl red, bromcresol purple, bromocresol green, chlorophenol red, bromothymol blue, phenol red, cresol purple, Creosol red, thymol blue, phenolphthalein, thymolphthalein, indigo carmine, alizarin yellow R, alizarin red S, pentamethoxy red, tropeolin O, tropeolin OO, tropeolin OOO, 2,4-dinitrophenol, tetrabromophenol blue, Neutral red, Chlorophenol red, 4-Nitrophenol, p-Xylenol blue, Indigo carmine, p-Xylenol blue, Eosin, bluish, Epsilon blue, Bromothymol blue, Thymolphthalein, Titan yellow, Alkali blue, 3-Nitrophenol, Bromoxylenol blue, Crystal violet, Cresol red, Congo red, Bromophenol blue, Quinaldine red, 2,4-Dinitro phenol, 2,5-Dinitrophenol, 4-(Dimethylamino) azobenzol, Bromochlorophenol blue, Malachite green oxalate, Brilliant green, alizarin sodium sulfonate, Eosin yellow, Erythrosine B, α-naphthyl red, p-ethoxychrysoidine, p-nitrophenol, azolitmin, neutral red, rosolic acid, α-naphtholbenzein, Nile blue, salicyl yellow, diazo violet, nitramine, Poirrier's blue, trinitrobenzoic acid, Congo red, Azolitmin, Neutral red, Nile red, Cresol Red, Alizarine Yellow R and salts thereof.

If the test liquid comprise or is an oil, oil-soluble dyes can be used in the indicator layer. Example of such dyes include but are not limited to Unicert Yellow, Unicert Red, Unicert Violet, Unicert Blue, Unicert Green, Fluorescent Yellow 131SC, Lime Green 7201, Blue 7010, Royal Blue 7030, Red 7335, and Violet 7146. Accordingly, the surface tension sensors described herein can be used on aqueous or oil fluid samples, e.g., including incorporation of an appropriate dye in the indicator layer.

In some embodiments of various aspects described herein, the selectively wetting layer can comprise microfibers. The size of microfibers can vary with different applications and/or desired CWST values. In some embodiments, the microfibers can have a diameter of about 0.5 μm to about 2.5 μm.

In some embodiments of various aspects described herein, the selectively wetting layer is porous. The desired porosity can be determined by one of skill in the art. The porosity has to be high enough such that the liquid wetting the selectively wetting layer can readily wet the indicator layer as well. In some embodiments, the porosity has to be high enough such that a desired roughness is introduced into the selectively wetting layer, but to be low enough such that the liquid in contact with the selectively wetting layer will not immediately pass through the selectively wetting layer and wet the indicator layer. In some embodiments, the porosity of the selectively wetting layer can be about 50% to about 90%. In some embodiments, the porosity of selectively wetting layer can be comparable between high and low CWST sensors.

In some embodiments of various aspects described herein, the indicator layer can comprise nanofibers. The size of microfibers can vary with different applications and/or desired CWST values. In some embodiments, the nanofibers can have a diameter of about 50 nm to about 300 nm.

In some embodiments of various aspects described herein, the selectively wetting layer can be porous. The desired porosity can be determined by one of skill in the art. In some embodiments, the indicator layer can have a porosity of about 30% to about 80%.

In some embodiments of various aspects described herein, the selectively wetting layer can comprise a rough surface. The rough surface can be generated, for example, by a process comprising soft lithography, hard lithography, reactive ion etching, acid etching, salt leaching, freeze drying, spray drying, gas foaming, electrospraying, electrospinning, weaving, pressing pulp, polyelectrolyte multilayer assembly, or any combinations thereof.

In some embodiments of various aspects described herein, the selectively wetting layer and/or the indicator layer can comprise at least two polymers described herein. In some embodiments, the selectively wetting layer and/or the indicator layer can comprise at least about 50% PCL.

In some embodiments, the selectively wetting layer can comprise a core material doped with varying amounts of at least one or more hydrophobic agents (e.g., hydrophobic polymer(s) and/or small molecule(s)) and/or hydrophilic agents (e.g., hydrophilic polymer(s) and/or small molecule(s)) to manufacture different sensor CWSTs according to the need of an application. For example, as shown in Examples 4-7 and Table 1, different amount of a hydrophobic polymer (e.g., but not limited to PGC-C18) can be added to a core polymer (e.g., but not limited to PCL) to produce a “milk sensor” with a sensor CWST of about 45-49 mN/m and a “urine sensor” with a sensor CWST of 50-53 mN/m.

In some embodiments of various aspects described herein, the selectively wetting layer can comprise about at least about 50% (by weight) core material or more, including, e.g., at least about 60%, at least about 70%, at least about 80%, at least about 90%, at least about 95% or more, core material.

In some embodiments of various aspects described herein, the selectively wetting layer can comprise no more than 50% (by weight) additives (e.g., hydrophobic polymer and/or hydrophilic polymer) or less, including, e.g., no more than 40%, no more than 30%, no more than 20%, no more than 10%, no more than 5%, no more than 3%, no more than 1% or lower, additives.

In some embodiments of various aspects described herein, the selectively wetting layer can comprise about 50%-95% (by weight) PCL and about 5%-50% (by weight) PGC-C18. In some embodiments of various aspects described herein, the selectively wetting layer can comprise about 90%-95% PCL and about 5%-10% PGC-C18.

In some embodiments of various aspects described herein, the selectively wetting layer can comprise about 50%-95% (by weight) PCL and about 5%-50% (by weight) PGC-OH. In some embodiments of various aspects described herein, the selectively wetting layer can comprise about 90%-95% PCL and about 5%-10% PGC-OH.

In some embodiments, the indicator layer can comprise (i) a core material doped with varying amounts of at least one or more hydrophilic agents (e.g., hydrophilic polymer(s) and/or small molecule(s)) such that the hydrophilicity of the indicator layer reaches an apparent contact angle of <10° with any test fluid sample (e.g., a fluid sample derived from a healthy subject vs. an unhealthy subject) and (ii) at least one detection agent.

In some embodiments of various aspects described herein, the indicator layer can comprise about at least about 50% (by weight) core material or more, including, e.g., at least about 60%, at least about 70%, at least about 80%, at least about 90%, at least about 95% or more, core material. In some embodiments, the indicator layer can essentially consist of or consist of a hydrophilic material without any dopants needed.

In some embodiments of various aspects described herein, the indicator layer can comprise no more than 50% (by weight) hydrophilic polymer or less, including, e.g., no more than 40%, no more than 30%, no more than 20%, no more than 10%, no more than 5%, no more than 3%, no more than 1% or lower, hydrophilic polymer.

In some embodiments of various aspects described herein, the indicator layer can comprise about 0.5%-15% (by weight) detection agent, or about 1%-10% (by weight) detection agent, or about 3%-8% (by weight) detection agent.

In some embodiments of various aspects described herein, the indicator layer can comprise about 80%-90% PCL, about 5%-10% PGC-OH, and about 3%-10% detectable agent.

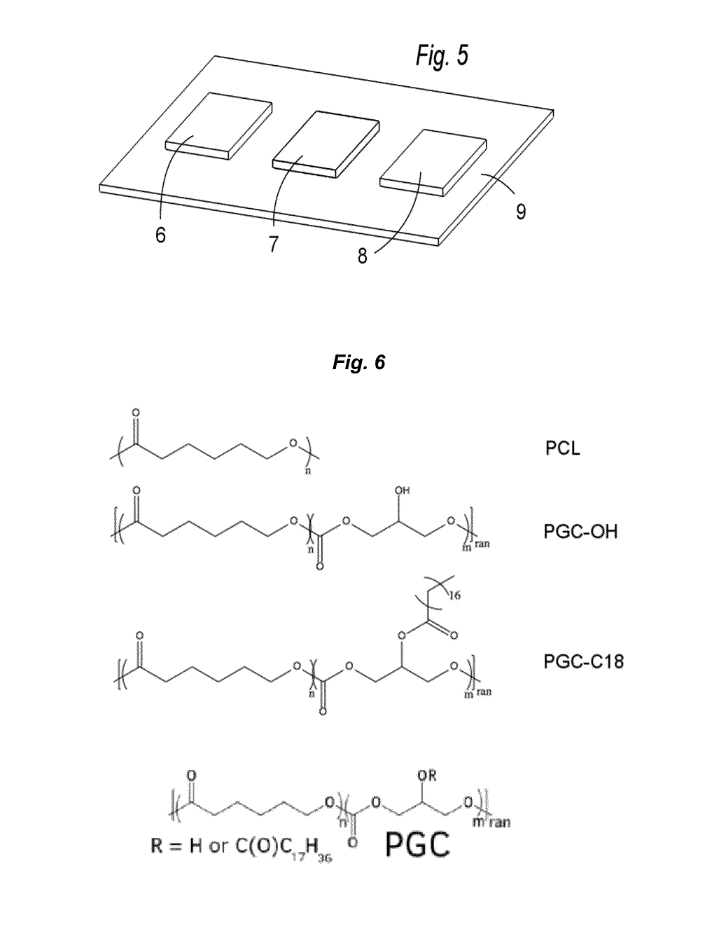

As shown in FIG. 5, one 7 or multiple sensors 6, 7, 8 can be affixed to a support 9, for instance to provide positive and negative controls (e.g., a selectively wetting layer (e.g., in a form of mesh) that always wets and a mesh which never should, for liquid in a certain surface tension range). Accordingly, a portable device comprising one or multiple (e.g., at least 2, at least 3 or more) surface tension sensors described herein is also provided herein. The portable device can further comprise at least one control sensor disposed on the solid substrate surface, wherein the control sensor generates a reference signal.

In some embodiments, at least two surface tension sensors can be disposed on the solid substrate surface of a portable device described herein. Examples of solid substrates include, but are not limited to, cellulose, glass, and/or polymer.

In some embodiments, the pre-determined CWST of at least two surface tension sensors disposed in the portable device can differ from each other. In some embodiments, the pre-determined CWST of at least two surface tension sensors disposed in the portable device can be the same.

While the preferred embodiments of the invention have been described above, it should be understood that changes in form, structure, arrangement, and practice that differ from those herein illustrated or detailed may be made within the underlying idea of the invention.

Embodiments of the surface tension sensor are based, at least in part, on the principles of wetted and unwetted states and their metastability. These principles can be used to vary the interaction of a liquid with a surface (42). In contrast, embodiments of various aspects described herein are based on surface tension principles to detect the changes in liquids such as water, urine, blood, or breast milk with the surface tension sensor or device described herein. For example, in some embodiments, the surface tension sensor or device described herein relies upon the change in hydrophobicity of the breast milk sample, which is directly related to the fat concentration.

Surface tension is the tendency of a liquid to resist an increase in its surface area exposed to a gas. It is measured in units of force per length (N/m), or equivalently as energy per area (J/m2) and when applied to a solid-liquid interface it is often called surface free energy. The measurement of the surface tension of a liquid with air is measured by the capillary rise, Wilhelmy plate, du Nouy ring, drop weight, pendant drop, spinning drop, or maximum bubble pressure methods (1).

An aqueous droplet on a rough hydrophilic surface, when in the fully wetted (Wenzel) state, displays a decreased apparent contact angle (θ*) compared to that of a smooth surface of the same material. Rough hydrophobic materials, in contrast, exhibit increased θ* when they are partially wetted in the composite Cassie-Baxter (CB) state (2-4). If θ*>150°, it is known as superhydrophobic, a class of material being researched for self-cleaning (5), drag reduction (6), water collection (7), and drug delivery applications (8,9). However, if a material and liquid have solid-air and solid-liquid interfacial surface tensions that are very similar, a small change in liquid surface tension can cause a transition from a high apparent contact angle (CB state) to complete wetting (Wenzel state). The rapid transition from CB to Wenzel states in response to small surface tension changes are previously discussed (10,11), but no practical applications of the observation has been explored. The rapid transition from CB to Wenzel states in response to small surface tension changes forms at least part of the basis for the sensitivity of surface tension sensors, devices, kits and/or methods described herein.

The critical wetting surface tension (CWST)—a characteristic of a solid surface—also known as critical surface tension, is generally understood to be the highest surface tension of a liquid that fully wets a material. This value can be, for example, determined by creating a Zisman plot and extrapolating until cos(θ*)=1, where θ* is the apparent contact angle. However, the applicability of this approach can vary with different types of liquids (12) and/or metastable CB states θ* that change over time. In some embodiments, the term “critical wetting surface tension” or “CWST” refers to the range between the surface tension of a liquid that will immediately wet a surface and that of a liquid that will maintain a non-wetted state for a pre-determined period of time. In some embodiments, the pre-determined period of time can be less than 15 minutes, less than 10 minutes, less than 5 minutes, less than 3 minutes, less than 1 minute or shorter. In some embodiments, the term “critical wetting surface tension” or “CWST” refers to the range between the surface tension of a liquid that will immediately wet a surface and that of a liquid that will maintain a non-wetted state (θ*>90°) for about 5 minutes.

The requirements for the surface tension sensor or device design are fourfold: (1) the sensor must have tunable and repeatable hydrophobicity with high enough porosity to provide sensitivity; (2) the entire sensor or device must be small, portable, and not reliant on power or complex instruments; (3) the entire sensor or device must be easy to operate; and (4) the results must be easy to read. To meet these requirements, one of the exemplary designs includes a mesh with a two-layer structure. The top layer provides selective wetting, and the more hydrophilic lower layer quickly absorbs liquid exposed to it and changes color due to an incorporated indicator dye (FIG. 3 and FIG. 4).

Additional polymers suitable for use in the selective wetting layer and/or indicator layer include, but are not limited to, Teflon, polystyrene, modified polystyrene, polypropylene, polyurethane, ethylene vinyl alcohol, (E/VAL), cellulose, lignocellulose, fluoroplastics, (PTFE), (FEP, PFA, CTFE, ECTFE, ETFE), fluorosilanes, polyacrylates, (Acrylic), polybutadiene, (PBD), polybutylene, (PB), polydimethylsioxane (PDMS), poly(ε-caprolactone) (PCL), poly(glycerol-co-ε-caprolactone) (PGC-OH), poly(glycerol monostearate-co-ε-caprolactone) (PGC-C18) polyethylene, (PE), polyethylenechlorinates, (PEC), polylactide, (PLA), poly(lactic-co-glycolic acid), (PLGA), poly(lactic acid-co-glycerol monostearate), (PLA-PGC18), polymethylpentene, (PMP), polypropylene, (PP), polyvinylchloride, (PVC), polyvinylidene chloride, (PVDC), acrylonitrile butadiene styrene, (ABS), Polyamide, (PA), (Nylon), polyamide-imide, (PAI), polyaryletherketone, (PAEK), (Ketone), polycarbonate, (PC), Polyektone, (PK), polyester, polyetheretherketone, (PEEK), polyetherimide, (PEI), polyethersulfone, (PES), polyimide, (PI), polyphenylene oxide, (PPO), polyphenylene sulfide, (PPS), polyphthalamide, (PTA), polysulfone, (PSU), allyl resin, (Allyl), melamine formaldehyde, (MF), phenol-formaldehyde plastic, (PF), polyester, polyimide, (PI), silicone, silicon, or silicon nitride.

Aspects disclosed herein relate to devices for spectroscopically (e.g., visually) determining if a liquid has been wetted or absorbed into a layer of a porous material. Certain embodiments provide a surface tension sensor or device, which comprises an indicator that makes use of the change in color observed when indicator molecules respond to a change in pH. Indicators are typically complex organic weak acids or weak bases comprising a UV, visible, or IR chromophore with an absorbance maximum that varies as a function of the pH of the environment. Such molecules are, independently for each occurrence, able to accept or to donate a proton, as represented by equilibrium equation (1), wherein a general indicator of the formula HX is ionized in solution:

HX<=>H⁺+X⁻ (1)

In certain embodiments, the detecting agent or detectable agent is used in conjunction with a base. Alternatively, the detecting agent or detectable agent is a small molecule or polymer that undergoes a color change in response to a change in oxidation state. In certain embodiments wherein the detecting agent or detectable agent is absorbed or covalently attached to a substrate, the base can be added to the test liquid and then the liquid can become in contact with the sensor to afford a signal. In certain embodiments, the liquid is passed through a resin or filter which is basic, followed by exposure to the detecting agent or detectable agent, which then affords a signal. The time of measurement is short, such that a visual readout is achieved in less than a minute. More than one measurement may be made in a single day. In certain embodiments, molecules that undergo a change in their chemical structure so as to give a change in an electrochemical signal and/or response may also be used as detecting agents or detectable agent.

In some embodiments of the surface tension sensor or device described herein, the detection agent or detectable agent can be selected from the group consisting of, but not limited to: litmus, bromophenol blue, bromophenol red, cresol red, α-naphtholphthalein, methyl purple, thymol blue, methyl yellow, methyl orange, methyl red, bromcresol purple, bromocresol green, chlorophenol red, bromothymol blue, phenol red, cresol purple, Creosol red, thymol blue, phenolphthalein, thymolphthalein, indigo carmine, alizarin yellow R, alizarin red S, pentamethoxy red, tropeolin O, tropeolin OO, tropeolin OOO, 2,4-dinitrophenol, tetrabromophenol blue, Neutral red, Chlorophenol red, 4-Nitrophenol, p-Xylenol blue, Indigo carmine, p-Xylenol blue, Eosin, bluish, Epsilon blue, Bromothymol blue, Thymolphthalein, Titan yellow, Alkali blue, 3-Nitrophenol, Bromoxylenol blue, Crystal violet, Cresol red, Congo red, Bromophenol blue, Quinaldine red, 2,4-Dinitro phenol, 2,5-Dinitrophenol, 4-(Dimethylamino) azobenzol, Bromochlorophenol blue, Malachite green oxalate, Brilliant green, alizarin sodium sulfonate, Eosin yellow, Erythrosine B, α-naphthyl red, p-ethoxychrysoidine, p-nitrophenol, azolitmin, neutral red, rosolic acid, α-naphtholbenzein, Nile blue, salicyl yellow, diazo violet, nitramine, Poirrier's blue, trinitrobenzoic acid, Congo red, Azolitmin, Neutral red, Nile red, Cresol Red, Alizarine Yellow R and salts thereof.

In some embodiments, the use of salt, including, but not limited to sodium chloride, potassium chloride, magnesium chloride, calcium chloride, sodium acetate, potassium acetate, sodium citrate, potassium citrate, etc. as part of the detection scheme can be employed, where the increase in the salt concentration of the sample provides an increase in the conductivity of the sample as measured via a change in current.

In some aspects, devices for measuring the surface tension of water or biological liquids are also provided herein. The devices can be used to aid diagnosis of abnormal levels of surfactants for medical or public health reasons. Some embodiments are directed to monitoring the calorie content of breast milk as a function of the mother's food intake in order to know or to optimize the number of calories in her breast milk. In certain embodiments, a process or method of measuring the calorie content in milk either before or after feeding an infant or both, and optionally repeating this procedure such that good nutritional behavior may be adopted is provided. In other embodiments, measurements of urine surface tension are made to aid diagnosis of liver or kidney disease. Additional embodiments are directed to the detection and measurement of surfactants or microbes in drinking water, rivers, streams, lakes, or oceans. In other embodiments, measurements of droplets of blood wetting into the sensor may indicate surface tension changes or clotting abnormalities. Other aspects relate to the provision of kits for conveniently and effectively implementing the methods associated with the devices disclosed herein. These kits can be used in the home, workplace, field, or on the go.

In one aspect, provided herein is a sensor or a device, e.g., a portable, fast, reliable monitor or device, for determining the surface tension of a liquid. The kit and methods to prepare the sensors are also provided herein. As such, examples of applications include, but are not limited to: parents and caregivers could detect breast milk with abnormally low caloric content; patients and health care workers could monitor surfactant levels in urine, blood, or other bodily fluids; and surveyors and public health workers could monitor surfactants in water.

In another aspect, provided herein is a method of determining surface tension of a fluid sample. The method comprises (a) contacting the fluid sample with a surface tension sensor described herein, for example, contacting the fluid sample with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST), and the indicator layer comprising a hydrophilic material and a detectable agent, wherein the detectable agent generates a detectable signal upon wetting of the indicator layer; (b) detecting a detectable signal from the indicator layer; and (c) determining surface tension of the fluid sample to be below the pre-determined CWST if a detectable signal from the indicator layer is present; or determining surface tension of the fluid sample to be at or above the pre-determined CWST if a detectable signal from the indicator layer is absent.

Various amounts of the liquid droplets can be used on the sensors, devices, and/or kits described herein. In some embodiments, a droplet of between 0.5 and 1.0 μL can be added onto the sensor. In some embodiments, a droplet of between 1.0 and 5.0 μL can be added onto the sensor. In some embodiments, a droplet of between 1.0 and 10.0 μL can be added onto the sensor. In some embodiments, a droplet of between 5 and 10.0 μL can be added onto the sensor. In some embodiments, a droplet of between 20 and 50 μL can be added onto the sensor. In some embodiments, a droplet of between 10 and 50 μL can be added onto the sensor. In some embodiments, a droplet of between 50 and 100 μL can be added onto the sensor.

In some embodiments, the method can further comprise allowing the contact of the fluid sample with the selectively wetting layer for no more than 15 minutes, prior to said detecting step. In some embodiments, the waiting can last for between 1 and 10 seconds. In some embodiments, the waiting can last for between 5 and 30 seconds. In some embodiments, the waiting can last for between 10 and 30 seconds. In some embodiments, the waiting can last for between 30 and 60 seconds. In some embodiments, the waiting can last for between 1 and 5 minutes. In some embodiments, the waiting can last for between 5 and 15 minutes. As the surface tension sensors described herein rely on the transition from the unwetted state to a wetted state, and the non-wetted state is a metastable phenomenon, the waiting time window before measurement/detection has to be pre-determined, which can vary with the design (e.g., polymer composition, fiber diameters, and/or pore size) of the surface tension sensors described herein. In general, the waiting time window is at least same as the “slow wetting” time or longer.

In some embodiments, the method can further comprise observing the sensor for signs of wetting.

In some embodiments, the method can further comprise interpreting sensor results in part of a diagnosis of disease or condition.

In some embodiments, the method can further comprise identifying condition or status of the fluid sample based on the determined surface tension of the fluid sample.

In some embodiments, the method can further comprise regularly monitoring the results from the sensor. This can provide different information depending on the application, e.g., to assess treatment outcomes, nutrition habits, pollution of a body of water, quality of drinking water, or other medical or public health outcome.

The fluid sample can be collected from any source. Non-limiting examples of the fluid sample can be selected from the group consisting of water, food products (e.g., milk), bodily fluid (e.g., blood, urine, saliva, tears, lymphatic fluid, cerebrospinal fluid), breast milk, infant formula, and any combinations thereof.

Surface tension is the resistance of a fluid to increasing its surface area with air. Liquids with strong intermolecular interactions such as hydrogen bonding (e.g. pure water) or electrostatic interactions (e.g. water with high concentrations of salts) will have high surface tensions. Liquids with less strong interactions, such as those limited to nonpolar interactions such as Van der Waals will have lower surface tensions. In a small aqueous droplet, diffusion to the liquid-air surface is not limiting and surfactants, when present, accumulate at the air-liquid interface, lowering the surface tension. Accordingly, surface tension, especially when measured in small droplets, provides a sensitive measure of surfactant concentrations. There are many scenarios in which a measure of surfactant levels would be of great benefit, especially in home care or field settings.

For example, one such application is in measuring the breast milk of mothers. The U.S. Surgeon General recommends exclusive breastfeeding infants for the first 6 months of life (27), yet 83% of mothers stop exclusive breastfeeding before this time (28), usually out of concern that their breast milk is not providing adequate nutrition and calories compared to formula (29). The caloric content of milk is strongly correlated with fat content, the most common measurement methods of which require a centrifuge and therefore are often too expensive and bulky to employ in a home or field setting (30). Milk lipids are effective surfactants, lowering the surface tension from 47.3±1.2 mN/m for low calorie (skim) milk to 41.9±1.1 mN/m for high calorie (whole) milk (31).

Accordingly, one aspect provided herein is a method of determining fat or caloric content of milk. The method comprises (a) contacting the milk with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST) corresponding to a reference milk (with known fat or caloric content), and the indicator layer comprising a hydrophilic material and a detectable agent, wherein the detectable agent generates a detectable signal upon wetting of the indicator layer; (b) detecting a detectable signal from the indicator layer; and (c) identifying the milk to have a higher caloric content than that of the reference milk if a detectable signal from the indicator layer is present; or identifying the milk to have a lower caloric content than that of the reference milk if a detectable signal from the indicator layer is absent. In some embodiments, the reference milk can be skim milk.

In some embodiments, the milk can be breast milk. In some embodiments, the pre-determined CWST can be between 43 mN/m and 48 mN/m or between 45 mN/m and 48 mN/m.

In another example, the surface tension of normal urine is 57.1±1.5 mN/m, which can be determined by the concentrations of surfactants such as urinary bile acid (32,33). For example, the concentration of bile acid is normally 1.1±0.5 μM, but is increased for example to 30.0±20.6 μM in biliary stenosis (34), and to 151±15 μM in chronic liver disease (35). The increased concentration of the bile acid reduces the surface tension of urine below 50 mM/m in both cases, so a measurement of surface tension can be helpful in diagnosis. Additionally, it has been previously observed that urine is more apt to foam, due to lowered surface tension, when a patient has proteinuria (36), making surface tension a useful indicator of kidney function.

Accordingly, another aspect provided herein is a method of diagnosing a disease or disorder associated with the level of a steroid or surfactant in a body fluid of a subject. The method comprises: (a) contacting a fluid sample collected from the subject with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST) corresponding to a reference steroid level, and the indicator layer comprising a hydrophilic material and a detectable agent, wherein the detectable agent generates a detectable signal upon wetting of the indicator layer; (b) detecting a detectable signal from the indicator layer; and (c) identifying the subject to have a higher steroid/surfactant level than the reference steroid/surfactant level if a detectable signal from the indicator layer is present; or identifying the subject to have a comparable or lower steroid level than the reference steroid/surfactant level if a detectable signal from the indicator layer is absent.

In some embodiment, the fluid sample can be urine. An exemplary steroid/surfactant in urine can comprise bile acid. In these embodiments, the reference steroid/surfactant level can correspond to a level of bile acid in a urine sample from a normal healthy subject.

In some embodiments, the pre-determined CWST can be between 48 mN/m and 54 mN/m.

In some embodiments, the method can further comprise identifying the subject to have a liver disease when the detectable signal from the indicator level is present. Exemplary liver disease that can be diagnosed using the method described herein include, e.g., biliary stenosis or chronic liver disease.

There have been reports that the surface tension of blood decreases when some enzymes have higher activity (37) or when levels of some proteins such as IgG are high (38). Also, it has been observed that blood surface tensions increase from 49.8±1.7 in normal patients to 60.6±3.9 mN/m during myocardial infarction (39). Accordingly, various aspects described herein can also be applied to determine level(s) of component(s), e.g., enzymes, proteins or biomarkers, in blood. In some embodiments, by comparing the blood surface tension of a subject to a reference level, one can determine whether the subject has, or has a risk of developing a disease or disorder, e.g., myocardial infarction.

In some embodiments, the surface tension sensors, devices, kits, and/or methods described herein can be used for surface tension measurements in the field of testing drinking water, rivers and lakes. The surface tension of river water is normally near 72 mN/m but some industrial surfactants can reduce below 50 mN/m at concentrations in the μM range (40). Further, bacteria cell walls and especially the surfactants they produce lower water surface tension markedly (12,41).

Consequently, there exists a need to detect and monitor the surface tension of water and biological liquids at home and in the field. While the present invention may not provide the precision of the Wilhelmy plate or maximum bubble pressure methods, for many applications, ease of use, low cost, no need for power, and portability are more important for adoption and continued use.

In some embodiments, surface tension sensors, devices, and kits for use in different applications can include meshes that selectively absorb (wet) only liquids of specific surface tensions. Some embodiments include those that contain a dye that aids visualization of wetting, and others include this dye only in a separate layer of the mesh. Some embodiments include a series of sensors of varying critical surface tensions. Thus, it is an object of the present invention to provide a portable device allowing a minimally trained person an indication of the surface tension of water or a biological liquid, particularly adapted to a porous material which selectively absorbs liquid.

Liquid surface tensions can vary with temperature and/or humidity, so it is desirable to have these parameters be controlled or otherwise accounted for. If, for example, a sensor resolution is 1.0 m/mN, or the range of the surface tensions desired to be detected has a difference of about 1.0 mN/m, an array of multiple (e.g., at least two or more, including, e.g., at least three or more) similar sensors can be created such as illustrated in FIG. 5, each with a slightly different CWST, such that the user can use, e.g., a table or software, to look up which sensor is appropriate to use at the current temperature and/or humidity. For example, it has been reported (Houska, M. (1994). Prague: Institute of Agricultural and Food Information) that the surface tension of whole and skim milks decrease in surface tension by 0.6 and 1.0 mN/m, respectively, when temperature increases from 17° C. to 23° C. A high resolution 1.0 m/mN milk diagnostic sensor tuned for a CWST at 20° C. will not be as useful at either temperature extreme. However, an additional sensor tuned to a CWST which is 0.4 mN/m lower (than the CWST of the sensor tuned at 20° C.) could be used when temperature is higher, and another for low temperatures tuned to a CWST 0.4 mN/m higher (than the CWST of the sensor tuned at 20° C.) would allow the same detection across the entire 17° C. to 23° C. range. In this way, a surface tension measurement (e.g., in a diagnostic test) can use an array of sensors (e.g., at least two or more, including, e.g., at least three or more), each tuned to a slightly different CWST to account for differences in surface tension with temperature while still providing robust performance.

In a bodily fluid there are many agents that can act as surfactants. The surface tension sensors, devices, kits, and/or methods described herein can provide a measurement of overall surface tension.

In some embodiments of various aspects described herein, the surface tension sensors, devices, kits, and/or methods described herein can be used, alone or in combination with other diagnostic or screening tools.

### Kits

In certain embodiments, kits are provided for conveniently and effectively implementing the methods associated with the devices disclosed herein. These kits house sensors, pipettes, and bottles of liquid standards of known surface tensions. Such kits comprise any of the devices disclosed herein or a combination thereof, and a means for facilitating their use consistent with methods provided herein. Such kits provide a convenient and effective means for assuring that the methods are practiced in an effective manner. The compliance means of such kits includes any means that facilitates practicing a method described herein. Such compliance means include instructions, packaging, and dispensing means, and combinations thereof. Kit components may be packaged for either manual or partially or wholly automated practice of the foregoing methods. In other embodiments, embodiments disclosed herein contemplate a kit including devices described herein, and optionally instructions for their use.

Aspects disclosed herein also relate to provision of the aforementioned kit, which is portable and can be used indoors or outdoors including in the clinic, home, farm, zoo, or outdoors.

In one aspect, provided herein is a kit comprising at least one or multiple (e.g., at least 2, at least 3, at least 4 or more) sensors on one or more platforms, combined with one or more pipettes, and/or with bottles of liquids to be used as standard references, diluents, and/or dyes.

In some embodiments of various aspects described herein, a plot of the calorie content as a function of time and food intake can be obtained, which enables a mother to identify the best time to feed her newborn to ensure an adequate amount or even a high amount of fat or calorie content in her breast milk. By doing so, newborns can receive the calories that are needed for proper development. In some embodiments, the surface tension sensor, device and/or kit described herein can be useful for mothers in the feeding of infants and newborns who are of low birth-weight or are not gaining sufficient weight as a function of time. In these embodiments, the kit can also contain a logbook and/or chart and/or website address where the mother may record her caloric history. This can enable mothers to keep track of such variables as the historical readings, the time of day, time since last meal, and/or meal portion and type. Thus, information can be retrieved allowing the mother to make informed decision on when is the best time to breastfeed to obtain optimal caloric nutrition for the infant. The logbook, chart, or web database can allow the mother to privately maintain this information.

Embodiments of various aspects described herein can be defined in any of the following numbered paragraphs:
1. A method of determining surface tension of a fluid sample comprising:
   a. contacting the fluid sample with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST), and the indicator layer comprising a hydrophilic material and a detectable agent, wherein the detectable agent generates a detectable signal upon wetting of the indicator layer;
   b. detecting a detectable signal from the indicator layer; and
   c. determining surface tension of the fluid sample to be below the pre-determined CWST if a detectable signal from the indicator layer is present; or determining surface tension of the fluid sample to be at or above the pre-determined CWST if a detectable signal from the indicator layer is absent.
2. The method of paragraph 2, wherein the selectively wetting layer comprises microfibers.
3. The method of paragraph 2, wherein the microfibers have a diameter of about 0.5 μm to about 2.5 μm.
4. The method of any of paragraphs 1-3, wherein the indicator layer comprises nanofibers.
5. The method of paragraph 4, wherein the nanofibers have a diameter of about 50 nm to about 300 nm.
6. The method of any of paragraphs 1-5, wherein the pre-determined CWST is between 25 and 30 mN/m.
7. The method of any of paragraphs 1-5, wherein the pre-determined CWST is between 30 and 35 mN/m.
8. The method of any of paragraphs 1-5, wherein the pre-determined CWST is between 35 and 40 mN/m.
9. The method of any of paragraphs 1-5, wherein the pre-determined CWST is between 40 and 45 mN/m.
10. The method of any of paragraphs 1-5, wherein the pre-determined CWST is between 45 and 50 mN/m.
11. The method of any of paragraphs 1-5, wherein the pre-determined CWST is between 50 and 55 mN/m.
12. The method of any of paragraphs 1-5, wherein the pre-determined CWST is between 55 and 60 mN/m.
13. The method of any of paragraphs 1-5, wherein the pre-determined CWST is between 60 and 65 mN/m.
14. The method of any of paragraphs 1-5, wherein the pre-determined CWST is between 65 and 70 mN/m.
15. The method of any of paragraphs 1-5, wherein the pre-determined CWST is between 70 and 75 mN/m.
16. The method of any of paragraphs 1-15, wherein the selectively wetting layer comprises a rough surface.
17. The method of paragraph 16, wherein the rough surface is generated by a process comprising soft lithography, hard lithography, reactive ion etching, acid etching, salt leaching, freeze drying, spray drying, gas foaming, electrospraying, electrospinning, weaving, pressing pulp, polyelectrolyte multilayer assembly, or any combinations thereof.
18. The method of any of paragraphs 1-17, wherein the roughened and/or porous material or the hydrophilic material comprises at least one polymer selected from the group consisting of Teflon, polystyrene, modified polystyrene, polypropylene, polyurethane, ethylene vinyl alcohol, (E/VAL), cellulose, lignocellulose, fluoroplastics, (PTFE), (FEP, PFA, CTFE, ECTFE, ETFE), fluorosilanes, polyacrylates, (Acrylic), polybutadiene, (PBD), polybutylene, (PB), polydimethylsioxane (PDMS), poly(ε-caprolactone) (PCL), poly(glycerol-co-ε-caprolactone) (PGC-OH), poly(glycerol monostearate-co-ε-caprolactone), (PGC-C₁₈), polyethylene, (PE), polyethylenechlorinates, (PEC), polylactide, (PLA), poly(lactic-co-glycolic acid), (PLGA), poly(lactic acid-co-glycerol monostearate), (PLA-PGC₁₈), polymethylpentene, (PMP), polypropylene, (PP), polyvinylchloride, (PVC), polyvinylidene chloride, (PVDC), polyvinylpyrrolidone, (PVP), acrylonitrile butadiene styrene, (ABS), Polyamide, (PA), (Nylon), polyamide-imide, (PAI), polyaryletherketone, (PAEK), (Ketone), polycarbonate, (PC), Polyektone, (PK), polyester, polyetheretherketone, (PEEK), polyetherimide, (PEI), polyethersulfone, (PES), polyimide, (PI), polyphenylene oxide, (PPO), polyphenylene sulfide, (PPS), polyphthalamide, (PTA), polysulfone, (PSU), allyl resin, (Allyl), melamine formaldehyde, (MF), phenol-formaldehyde plastic, (PF), polyester, polyimide (PI), silicone, silicon, silicon nitride, and any combinations thereof.
19. The method of any of paragraphs 1-18, wherein the roughened and/or porous material or the hydrophilic material comprises at least two polymers.
20. The method of any of paragraphs 1-19, wherein the roughened and/or porous material or the hydrophilic material comprises at least about 50% PCL.
21. The method of any of paragraphs 1-20, wherein the roughened and/or porous material comprises about 90%-95% PCL and about 5%-10% PGC-C18.
22. The method of any of paragraphs 1-21, wherein the indicator layer comprises about 90% PCL, about 5% PGC-OH, and about 5% detectable agent.
23. The method of any of paragraphs 1-22, wherein the detectable agent is selected from the group consisting of litmus, bromophenol blue, bromophenol red, cresol red, α-naphtholphthalein, methyl purple, thymol blue, methyl yellow, methyl orange, methyl red, bromcresol purple, bromocresol green, chlorophenol red, bromothymol blue, phenol red, cresol purple, Creosol red, thymol blue, phenolphthalein, thymolphthalein, indigo carmine, alizarin yellow R, alizarin red S, pentamethoxy red, tropeolin O, tropeolin OO, tropeolin OOO, 2,4-dinitrophenol, tetrabromophenol blue, Neutral red, Chlorophenol red, 4-Nitrophenol, p-Xylenol blue, Indigo carmine, p-Xylenol blue, Eosin, bluish, Epsilon blue, Bromothymol blue, Thymolphthalein, Titan yellow, Alkali blue, 3-Nitrophenol, Bromoxylenol blue, Crystal violet, Cresol red, Congo red, Bromophenol blue, Quinaldine red, 2,4-Dinitro phenol, 2,5-Dinitrophenol, 4-(Dimethylamino) azobenzol, Bromochlorophenol blue, Malachite green oxalate, Brilliant green, alizarin sodium sulfonate, Eosin yellow, Erythrosine B, α-naphthyl red, p-ethoxychrysoidine, p-nitrophenol, azolitmin, neutral red, rosolic acid, α-naphtholbenzein, Nile blue, salicyl yellow, diazo violet, nitramine, Poirrier's blue, trinitrobenzoic acid, Congo red, Azolitmin, Neutral red, Nile red, Cresol Red, Alizarine Yellow R and salts thereof, and any combinations thereof.
24. The method of any of paragraphs 1-23, wherein the fluid sample has a volume of no more than 100 μL.
25. The method of any of paragraphs 1-24, further comprising allowing the contact of the fluid sample with the selectively wetting layer for no more than 15 minutes, prior to said detecting step.
26. The method of any of paragraphs 1-25, wherein the fluid sample is selected from the group consisting of water, food products (e.g., milk, wine, beer, alcoholic spirits), bodily fluid (e.g., blood, urine, saliva, tears, lymph fluid, cerebrospinal fluid), breast milk, infant formula, and any combinations thereof.
27. The method of any of paragraphs 1-26, further comprising identifying condition or status of the fluid sample based on the determined surface tension of the fluid sample.
28. A method of determining fat or caloric content of milk comprising
   a. contacting the milk with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST) corresponding to a reference milk (with known fat or caloric content), and the indicator layer comprising a hydrophilic material and a detectable agent, wherein the detectable agent generates a detectable signal upon wetting of the indicator layer;
   b. detecting a detectable signal from the indicator layer; and
   c. identifying the milk to have a higher caloric content than that of the reference milk if a detectable signal from the indicator layer is present; or
      identifying the milk to have a lower caloric content than that of the reference milk if a detectable signal from the indicator layer is absent.
29. The method of paragraph 28, wherein the milk is breast milk.
30. The method of paragraph 28 or 29, wherein the pre-determined CWST is between 43 mN/m and 48 mN/m.
31. The method of paragraph 30, wherein the pre-determined CWST is about 45 mN/m.
32. The method of paragraph 31, wherein the reference milk is skim milk.
33. A method of diagnosing a disease or disorder associated with the level of a steroid in a body fluid of a subject comprising:
   a. contacting a fluid sample collected from the subject with a selectively wetting layer of a surface tension sensor, wherein the surface tension sensor comprises the selectively wetting layer and an indicator layer, the selectively wetting layer comprising a roughened and/or porous material tuned to a pre-determined critical wetting surface tension (CWST) corresponding to a reference steroid level, and the indicator layer comprising a hydrophilic material and a detectable agent, wherein the detectable agent generates a detectable signal upon wetting of the indicator layer;
   b. detecting a detectable signal from the indicator layer; and
   c. identifying the subject to have a higher steroid level than the reference steroid level if a detectable signal from the indicator layer is present; or
      identifying the subject to have a comparable or lower steroid level than the reference steroid level if a detectable signal from the indicator layer is absent.
34. The method of paragraph 33, wherein the fluid sample is urine.
35. The method of paragraph 34, wherein the steroid comprises bile acid.
36. The method of paragraph 35, wherein the reference steroid level corresponds to a level of bile acid in a urine sample from a normal healthy subject.
37. The method of paragraph 36, wherein the pre-determined CWST is between 48 mN/m and 54 mN/m.
38. The method of paragraph 37, wherein the pre-determined CWST is about 50 mN/m.
39. The method of paragraph 38, further comprising identifying the subject to have a liver disease when the detectable signal from the indicator level is present.
40. The method of paragraph 39, wherein the liver disease is biliary stenosis or chronic liver disease.
41. A portable device comprising a solid substrate surface and at least one surface tension sensor disposed thereon, wherein said at least one surface tension sensor comprises at least one selectively wetting layer and at least one indicator layer, the selectively wetting layer comprising a roughened and/or porous material tuned to a pre-determined critical wetting surface tension (CWST), and the indicator layer comprising a hydrophilic material and a detectable agent, wherein the detectable agent generates a detectable signal upon wetting of the indicator layer.
42. The portable device of paragraph 41, further comprising at least one control sensor disposed on the solid substrate surface, wherein the control sensor generates a reference signal.
43. The portable device of paragraph 41 or 42 wherein at least two surface tension sensors are disposed on the solid substrate surface.
44. The portable device of paragraph 43, wherein the pre-determined CWST of said at least two surface tension sensors differs from each other.
45. The portable device of paragraph 44, wherein the pre-determined CWST of said at least two surface tension sensors are the same.
46. The portable device of any of paragraphs 41-45, wherein the solid substrate surface comprises cellulose, paper, glass, and/or polymer.
47. The method of any of paragraphs 1-40, wherein the detectable signal is detected upon the fluid sample in contact with the selectively wetting layer for a pre-determined period of time.
48. The method of paragraph 47, wherein the pre-determined period of time is about 1 minute to about 5 minutes.
49. The method of any of paragraphs 1-40, wherein the method is used to distinguish a first fluid sample from a second fluid sample by performing the method with the first fluid sample and the second fluid sample simultaneously or sequentially.
50. The method of paragraph 49, wherein the surfactant level in the first fluid and the second fluid are different.
51. The method or the portable device of any of paragraphs 1-50, wherein the indicator layer comprises fibers.
52. The method or the portable device of paragraph 51, wherein the fibers have a diameter of about 0.5 μm to about 50 μm.
53. The method or the portable device of any of paragraphs 1-52, where the apparent contact angle of the selectively wetting layer is at least 80° greater (including, e.g., at least 85° greater, at least 90° greater, at least 95° greater, at least 100° greater) than that on the indicator layer.
54. The method or the portable device of any of paragraphs 1-53, wherein the selectively wetting layer and the indicator layer are in contact with each other such that a liquid may or may not wet the selectively wetting layer, but if it does it will contact the indicator layer where it will wet.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.” Thus, in this specification and the appended claims, the singular forms “a,” “an,” and “the” include plural references unless the context clearly dictates otherwise.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. As used herein, the term “comprising” means that other elements can also be present in addition to the defined elements presented. The use of “comprising” indicates inclusion rather than limitation. The term “consisting of” refers to compositions, methods, and respective components thereof as described herein, which are exclusive of any element not recited in that description of the embodiment. As used herein the term “consisting essentially of” refers to those elements required for a given embodiment. The term permits the presence of elements that do not materially affect the basic and novel or functional characteristic(s) of that embodiment of the invention. Other than in the operating examples, or where otherwise indicated, all numbers expressing quantities of ingredients or reaction conditions used herein should be understood as modified in all instances by the term “about.” The term “about” when used in connection with percentages can mean±5%.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. The terminology used herein is for the purpose of describing particular embodiments only, and is not intended to limit the scope of the present invention, which is defined solely by the claims.

### EXAMPLES

The following examples are not intended to limit the scope of the claims to the invention, but are rather intended to be exemplary of certain embodiments. Any variations in the exemplified methods which occur to the skilled artisan are intended to fall within the scope of the present invention.

### Example 1

### Creation of a Polymer Blend with Tunable Hydrophobicity

The overall hydrophobicity of a surface tension sensor can be adjusted by altering the material or polymer hydrophobicity and/or the morphology and/or structure of the material. For example, in some embodiments, poly(ε-caprolactone), or PCL, were doped with varying amounts of the hydrophobic poly(glycerol monostearate-co-ε-caprolactone), and/or PGC-C18 or the hydrophilic copolymer poly(glycerol-co-ε-caprolactone), or PGC-OH. The hydrophobicity or superhydrophobicity of this polymer system can be tuned by altering the amounts or ratios of the core material (e.g. PCL) to the dopant material (e.g., PGC-C18 and/or PGC-OH), the monomer ratios, side chain conjugated onto the core material (e.g., PGC-OH), and any combinations thereof.

The respective chemical structures of PCL, PGC-OH and PGC-C18 are shown in FIG. 6.

In one embodiment, hydrophobic blends are created with PCL with PGC-C18, wherein the ratios of the two copolymer groups can be varied according to the desired degree of hydrophobicity or critical wetting surface tension. In some embodiments, the ratios of caprolactone to glycerol groups can range from about 1:20 to about 1:5. In some embodiments, the ratio of caprolactone to glycerol groups can be about 1:5. In some embodiments, the ratio of caprolactone to glycerol groups can be about 1:20.

To create more hydrophilic blends, in some embodiments, PCL can be doped with PGC-OH, wherein the ratios of the two copolymer groups can be varied according to the desired degree of hydrophobicity or critical wetting surface tension. In some embodiments, the monomer ratio can be about 1:5.

### Example 2

### Ranges of the Surface Tension Sensors

To develop a surface tension sensor, unlayered meshes were electrospun with different polymer blends to determine the highest and lowest surface tensions which can be detected by the surface tension sensor. Contact angle and surface tension measurements were made on a Kruss DSA100 Goniometer at 22.5±1.5° C., using 3 μL droplets and the Laplace-Young fitting method. Given enough time, all tested mixtures wet to the indicator layer (the energy minimum being a fully wetted hydrophilic layer) so the time until the apparent contact angle θ* is <90° was measured, after which wetting is rapid. Mixtures of water with propylene glycol were used to test wetting properties of the sensors, due to their low volatility and well-characterized surface tensions.

For example, a polymer blend with varying amounts of PCL and PGC-C18 or PGC-OH, as well as fiber diameter, was electrospun to form a mesh. FIG. 7A shows the range of surface tensions an electrospun mesh with varying amounts of PCL and PGC-C18 or of PCL and PGC-OH can resolve, e.g., from about 34 to 68 mN/m. Higher or lower surface tensions can also be resolved by varying the amounts of PCL, PGC-C18, and/or PGC-OH. In FIG. 7A, the upper error bars denote the surface tension of a droplet which will remain non-wetted for 5.0 minutes (the “slow wetting” time) and the lower error bars denote the surface tension of a droplet which is absorbed by the surface immediately (under 5 seconds, the “fast wetting” time). Thus, the difference between the upper series and the lower series define the sensor CWST range. FIG. 7B is another example showing that by altering the polymer composition and fiber diameter, the sensor range can be tuned between 45 and 65 mN/m. The surface tensions measured at the “slow wetting” time (e.g., at least 5 minutes or longer) and “fast wetting” time (e.g., less than 30 seconds or less) times define the sensor CWST.

### Example 3

### Surface Tension Sensors as Point-of-Care Diagnosis

Changes in the surface tensions of biological fluids can be used as indicators of medical conditions. Thus, it was sought to determine if a sensor that transitions from fully wetted to a non-wetted state at a specific surface tension could provide such a point of care test. A mesh that transition from a high apparent contact angle to fully wetted within the desired ranges was created. Further, the readout is desirable to be obvious to the naked eye, so the meshes should undergo a change when wetted. Accordingly, a two-layer electrospun polymer fiber mesh (sensor) comprising (i) a dye-loaded, absorbent, lower layer to aid visualization of wetting, and (ii) an upper layer that responds to a small decrease in surface tension by wetting, was developed. The sensor could provide a binary readout with only a droplet of fluid to operate. The upper layer was tuned to a predetermined critical wetting surface tension that varies with the condition of the sample to be analyzed.

In some embodiments, a surface tension sensor can comprise a selectively wetting layer of tunable hydrophobicity composed of electrospun poly(ε-caprolactone), or PCL, doped with hydrophobic poly(glycerol monostearate-co-ε-caprolactone), or PGC-C18. Beneath that, there is an “indicator” layer of PCL doped with hydrophilic poly(glycerol-co-ε-caprolactone), or PGC-OH and a pH indicator dye, bromocresol purple.

As proof of concept, a “milk sensor” and “urine sensor” were developed as described below for detecting two different example clinical conditions: low breast milk fat in Example 4 and elevated urinary bile acids in Example 5.

To manufacture these two sensors, PCL was purchased (Sigma, 70-90 kDa) while PGC-C18 and PGC-OH were synthesized following a procedure previously described in Refs. 54-55, with the exception that the 5-benzyloxy-1,3-dioxan-2-one and ε-caprolactone monomers were polymerized at a molar ratio of 1:20 for PGC-C18. This lower ratio reduces the hydrophobicity of the dopant to allow for more reliable tuning in the ranges for use in Examples 4-5 below. The PGC-C18 has M_{W} of 30.1 kDa and dispersity of 2.3, and the PGC-OH has M_{W} of 71.3 and a dispersity of 2.9. All polymer solutions are electrospun at 140-150 mg/ml in a 5:1 ratio of chloroform to methanol.

For both milk and urine sensors in Examples 4-5, the indicator layer included the same component, 90% PCL with 5-10% PGC-OH by weight with 5% bromocresol purple, a pH indicator. The selectively wetting layer of the “milk sensor” (Example 3) comprises 7.5% PGC-C18 and 92.5% PCL by weight, and the selectively wetting layer of the “urine sensor” (Example 4) comprises 5% PGC-C18 and 95% PCL. The composition of the selectively wetting layer varies in the milk sensor and urine sensor because the selectively wetting layer of each sensor was tuned to a critical wetting surface tension that varies with different types of liquids or samples to be analyzed, which will be further explained in Examples 4-8.

To electrospin, the selectively wetting layer and indicator layer solutions are pumped through 20 ga. needles at 5 ml/hr while voltages from 13-18 kV are applied, simultaneously for the first 5 minutes to form the indicator layer, then the voltage and flow to the indicator needle is stopped, and the selectively wetting layer alone is electrospun for a certain period of time: 5 minutes for the milk sensor and 2 minutes for the urine sensor. Electrospinning is a scalable manufacturing technique that uses high voltages to draw out fine fibers of a polymer solution into a non-woven mesh with high roughness. A representative resulting layered structure is shown in FIG. 8, and the selectively wetting layer needs to remain thin enough to be translucent so the color change after wetting of the indicator layer can be observed.

Testing of wetting used mixtures of water with propylene glycol, which was chosen for its low volatility and well characterized surface tensions (56). Contact angle and surface tension measurements were made on a Kruss DSA100 Goniometer at 22.5±1.0° C., using 3 μL droplets and the Laplace-Young fitting method. Eventually most mixtures would wet to the indicator layer (the global energy minimum being a fully wetted hydrophilic layer) so the measurements include the time until the apparent contact angle was <90°, after which only the Wenzel equation may apply (57-58) and wetting is usually rapid (10, 11, 59).

### Example 4

### Detection of Surface Tension Changes as a Result of Milk Fat Depletion

The caloric content of milk is strongly correlated with fat content. The most common measurement methods of measuring the fat content in milk generally require a centrifuge and therefore are often too expensive and bulky to employ in a home or field setting (30). Milk lipids are effective surfactants, lowering the surface tension from 47.3±1.2 mN/m for low calorie (skim) milk to 41.9±1.1 mN/m for high calorie (whole) milk (31). An electrospun mesh, using a selectively wetting layer comprising PGC-C18 above or co-spun with an indicator layer comprising PGC-OH and bromocresol purple, was tuned to have a CWST in the range between normal and low caloric content milks. In one embodiment, to create a high specificity sensor, the selectively wetting layer of the milk sensor mesh that wets at 45.0 mM/m but remains non-wetted at 48.0 mN/m was developed.

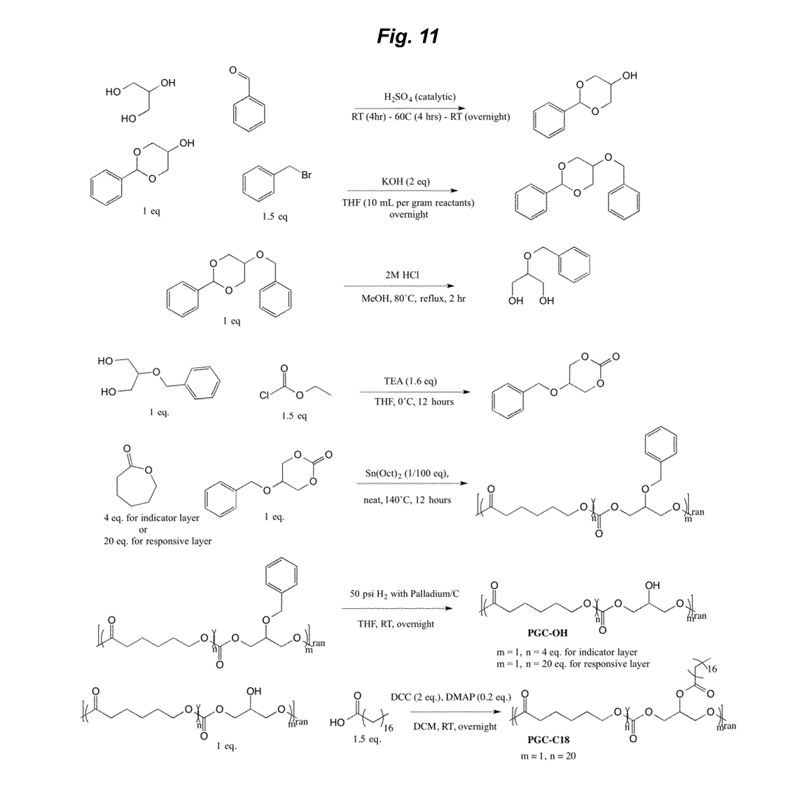

To develop such sensor mesh, in one embodiment, poly(ε-caprolactone) (PCL; Mw=70-90 kDa) is the main polymer component of the selectively wetting layer, doped with a hydrophobic polymer such as poly(glycerol monostearate-co-ε-caprolactone) (PGC-C18; 1:20 glycerol carbonate:caprolactone; Mw=31.3 kDa, DM=1.47). In one embodiment, the selectively wetting layer is 7.5% PGC-C18 and 92.5% PCL. The PGC-C18 was synthesized following the procedure as described in Wolinsky et al. Macromolecules. 40 (2007) 7065-7068, and also shown in FIG. 11.

Non-woven sensor meshes were fabricated from the polymer mixture using electrospinning, a scalable manufacturing technique that draws out fibers from a polymer solution under high voltage. See, e.g., Reneker et al., Polymer (2008) 49:2387; Agarwal et al., Prog. Polym. Sci. (2013) 38: 963. In some embodiments, the indicator layer can comprise about 85 or about 90% PCL with ˜5 or ˜10% PGC-OH (1:4) by weight with 5% bromocresol purple (BCP).

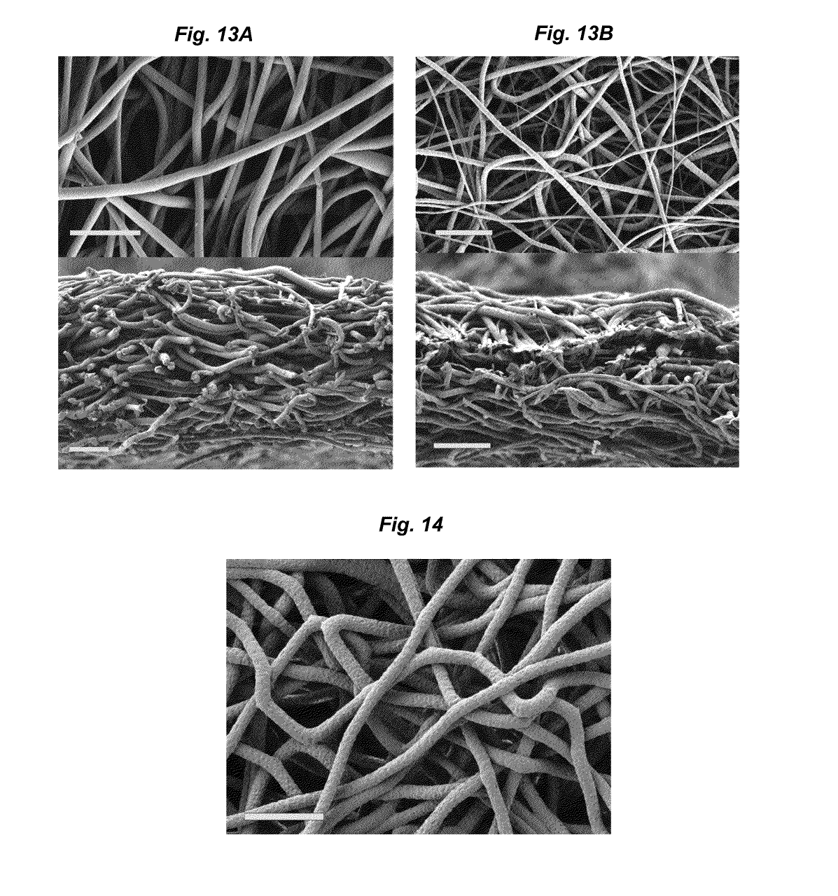

In some embodiments, the resulting non-woven mesh can form a layered structure (e.g., FIG. 8), where the selectively wetting layer can be made thin such that a rapid color change after wetting can be observed. In some embodiments, the selectively wetting layer material and the indicator layer material can be co-spun together to form a more integral structure (e.g., FIGS. 13A-13B)

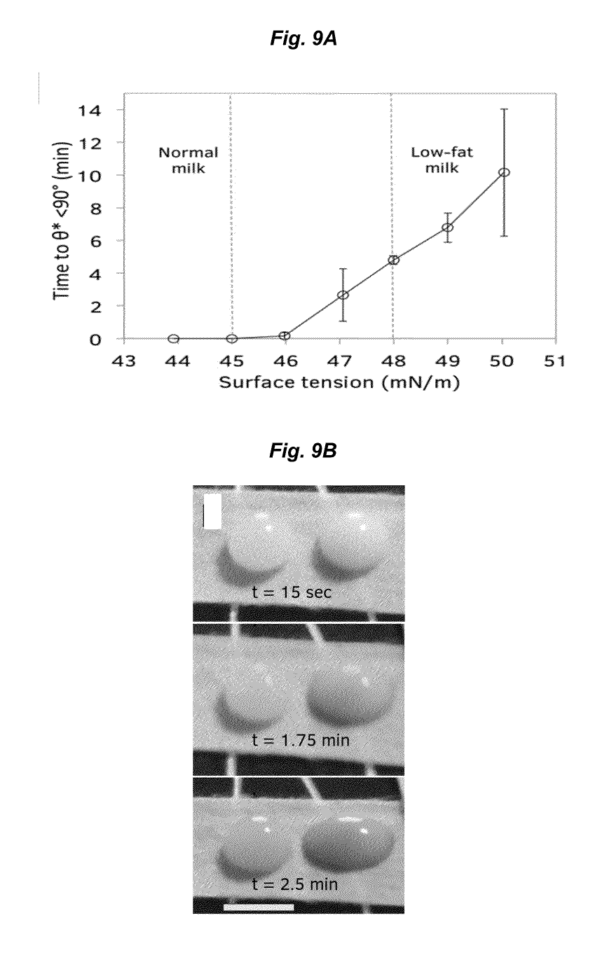

The electrospun mesh was then used to determine the time to wet with mixtures of propylene glycol and water. Contact angle and surface tension measurements were made on a Kruss DSA100 Goniometer at 22.5±1.5° C., using ˜3 μL droplets and the Laplace-Young fitting method. Given enough time, all tested mixtures would wet to the indicator layer (the energy minimum being a fully wetted hydrophilic layer) so the time until the apparent contact angle θ* is <90° was measured, after which wetting is rapid. Bormashenko et al., Langmuir (2012) 28: 3460; Murakami et al., Langmuir (2014) 30: 2061. Mixtures of water with propylene glycol were used to test wetting properties of the sensor, due to their low volatility and well-characterized surface tensions. Hoke Jr et al. J. Chem. Eng. Data (1992) 37: 331. As shown in FIG. 9A, the milk sensor mesh tuned to detect surface tensions in the range of milk showed large changes in wetting times, transitioning from immediate wetting to many minutes of non-wetting within just a few mN/m (e.g., 1-3 mN/m). In this example, the “slow wetting” time was 4 min, and the “fast wetting” time was 30 seconds.

As shown in FIG. 9A, the transition from wetting to non-wetting occurs in response to a change of 4 mN/m or less. Droplets from low fat milk (hence with low caloric content) were maintained in a non-wetted state on the electrospun mesh or surface tension sensor for many minutes, but droplets which have lower surface tension corresponding to normal milk are wetted immediately. Thus, the sensor is sensitive to discriminate samples with different fat contents.

Next, the utility of the sensor mesh to distinguish normal from low-fat breast milk was tested. Using normal human breast milk (e.g., obtained from Innovative Research) compared to breast milk diluted 1:2 with deionized water (modeling low-fat breast milk), FIG. 9B shows that the normal milk wetted the sensor and became purple whereas the low-fat breast milk remained non-wetted and white. These tests validated that properly tuned sensor meshes can resolve lipid content in milk.

### Example 5

### Detection of Surface Tension Changes as a Result of Increased Surfactant(s) (e.g., Bile Acids) in Urine

In some embodiments, the surface tension sensors described herein can also be tuned to detect urinary bile acids. The surface tension of normal urine is 57.1±1.5 mN/m, which is highly correlated with urinary bile acid concentration (49, 50), which is normally 1.1±0.5 μM, but is increased for example to 30.0±20.6 μM in biliary stenosis (51) and to 151±15 μM in chronic liver disease (52). These increases in concentrations of surfactants such as bile acids cause a reduction in urine surface tension to well below 50 mN/m. Additionally, it has been previously reported that urine is increasingly apt to foam when a patient has proteinuria (53), making surface tension a useful indicator of kidney function. Therefore, in this example, a high selectivity urine sensor mesh that wets at 50 mN/m but remains non-wetted at 54 mN/m was developed.

To develop such sensor mesh, in one embodiment, poly(ε-caprolactone) (PCL; Mw=70-90 kDa) is the main polymer component of the selectively wetting layer, doped with a hydrophobic polymer such as poly(glycerol monostearate-co-ε-caprolactone) (PGC-C18; 1:20 glycerol carbonate:caprolactone; Mw=31.3 kDa, DM=1.47). In one embodiment, the selectively wetting layer is 5% PGC-C18 and 95% PCL. The PGC-C18 was synthesized following the procedure as described in Wolinsky et al. Macromolecules. 40 (2007) 7065-7068, and also shown in FIG. 11.

Non-woven sensor meshes were fabricated from the polymer mixture using electrospinning, a scalable manufacturing technique that draws out fibers from a polymer solution under high voltage. See, e.g., Reneker et al., Polymer (2008) 49:2387; Agarwal et al., Prog. Polym. Sci. (2013) 38: 963. In some embodiments, the indicator layer can comprise about 85 or about 90% PCL with ˜5 or ˜10% PGC-OH (1:4) by weight with 5% bromocresol purple (BCP).

In some embodiments, the resulting non-woven mesh can form a layered structure (e.g., FIG. 8), where the selectively wetting layer can be made thin such that a rapid color change after wetting can be observed. In some embodiments, the selectively wetting layer material and the indicator layer material can be co-spun together to form a more integral structure (e.g., FIGS. 13A-13B)

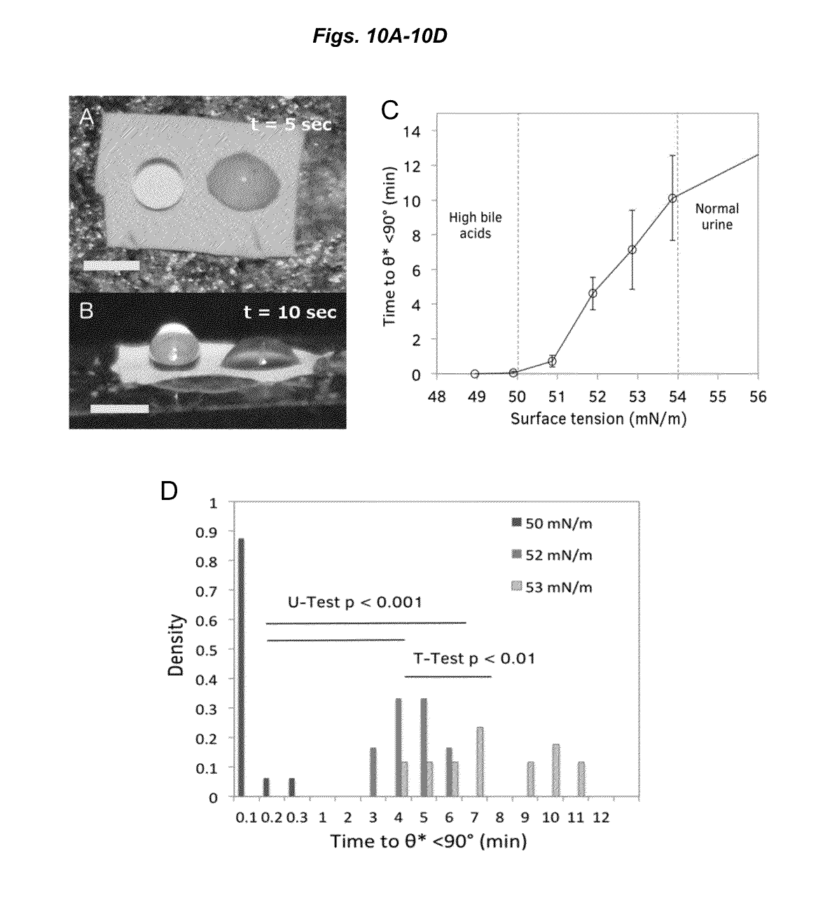

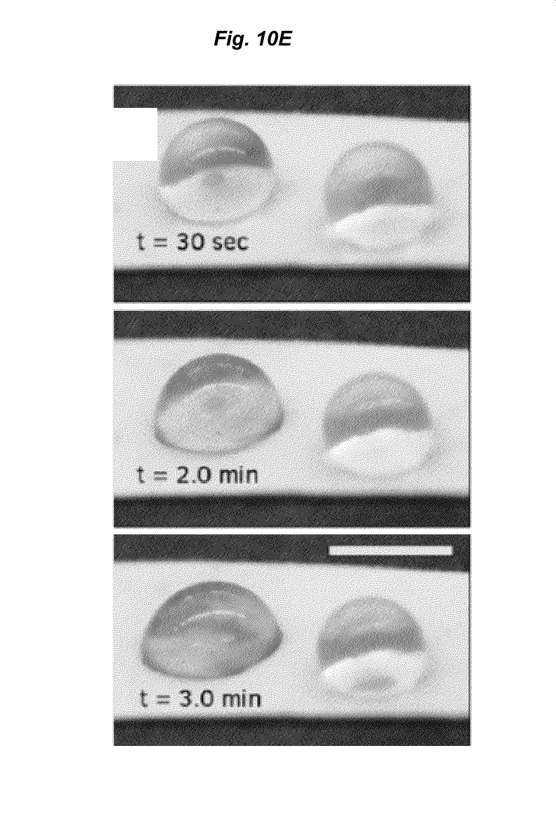

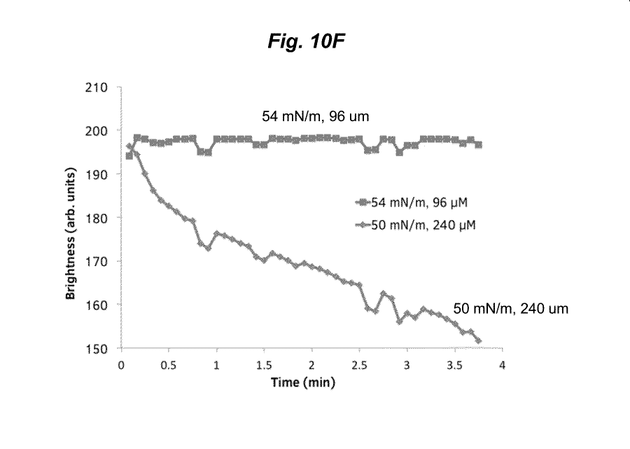

Contact angle and surface tension measurements were made on a Kruss DSA100 Goniometer at 22.5±1.5° C., using ˜3 μL droplets and the Laplace-Young fitting method. Given enough time, all tested mixtures would wet to the indicator layer (the energy minimum being a fully wetted hydrophilic layer) so the time until the apparent contact angle θ* is <90° was measured, after which wetting is rapid. Bormashenko et al., Langmuir (2012) 28: 3460; Murakami et al., Langmuir (2014) 30: 2061. Mixtures of water with propylene glycol were used to test wetting properties of the sensor, due to their low volatility and well-characterized surface tensions. Hoke Jr et al. J. Chem. Eng. Data (1992) 37: 331. As shown in FIG. 10C, the urine sensor mesh tuned to detect surface tensions in the range of urine showed large changes in wetting times, transitioning from immediate wetting to many minutes of non-wetting within just a few mN/m (e.g., 2-4 mN/m). The distribution of wetting times for the urine sensor mesh with 50, 52, and 53 mN/m propylene glycol/water solutions is shown in FIG. 10D. The lack of overlap between the wetting times using 50 mN/m solution with those of 52 or 53 mN/m solution indicates high sensitivity and specificity (Mann-Whitney U-test <0.001).

Next, the sensor was further evaluated using human urine. To make urine of different surface tension, a bile acid (deoxycholic acid, Alfa Aesar) was added into human urine until the surface tension as measured by the pendant drop method was either 50 mN/m (diseased state) or 54 mN/m (healthy state), which took 637 μM and 100 μM, respectively. These concentrations are more than seen physiologically, a difference, e.g., due to the freeze-thaw cycle of the urine sample. As shown in FIGS. 10A and 10B as well as in FIG. 10E, the droplet on the left with a surface tension of 54 mN/m remained unwetted and clear whereas the droplet on the right, with a surface tension of 50 mN/m, quickly wetted and became purple. The bromocresol purple dye incorporated in the lower hydrophilic layer made the wetted droplet easy to be identified with the unaided eye, even with the small droplet size. This Example validates that the propylene glycol mixtures modeled urine mixtures well and that, in some embodiments, the surface tension sensors described herein can resolve surfactant levels (e.g., bile acid levels) in clinical samples.

As shown in FIG. 10C, the transition from wetting to non-wetting occurs in response to a change of 4 mN/m or less. In this example, the “slow wetting” time is about 5 min and the “fast wetting” time is about 30 seconds. Droplets of normal urine are maintained in a non-wetted state on the surface tension sensor for many minutes, but droplets of urine with high deoxycholic acid, which have lower surface tension, are wetted immediately. Thus, the sensitivity of the sensor is sufficient to discriminate healthy from unhealthy samples, e.g., urine samples for detection of chronic liver diseases.

Presented herein are surface tension sensors that can visibly transition from or switch between non-wetted to complete wetted states within a range of 3-4 or 2-3 mN/m. A pH indicating dye incorporated into a lower, hydrophilic layer highlights wetting and aids identification with the naked eye. Examples 4-5 demonstrate, respectively, a milk sensor and a urine sensor tuned to a surface tension range corresponding to milk with different lipid levels or urine with varying bile acid levels. The urine sensor was evaluated directly with urine and shown to wet only with an abnormally high deoxycholic acid concentration. Thus, the surface tension sensors presented herein can be tunable to a specific surface tension for monitoring different liquids. The surface tension sensors presented herein are portable, simple to use, inexpensive to manufacture, and instrument-free, and requires no power and only a small sample volume, and are therefore useful for point-of-care diagnosis or self-monitoring in the field. Further, its tunable specificity can allow monitoring multiple liquids over varying surface tension ranges.

### Example 6

### Use of the Surface Tension Sensor to Alter Eating Habits and Thus the Caloric Content of Breast Milk

The U.S. Surgeon General recommends breastfeeding infants for the first 6 months of life (60), yet 83% of mothers stop exclusive breastfeeding before this time (61), usually out of concern that their breast milk is not providing adequate nutrition and calories compared to formula (62). In addition to reassuring mothers, measuring the calorie content of breast milk is helpful in managing low-birth-weight, preterm, and “failure to thrive” infants. For example, in the U.S., low-birth weight babies represent about 8 percent of the 4 million newborns; preterm babies represent about 11 percent; and 5-10% of infants receiving primary care show signs of “failure to thrive.” The most common methods for measuring breast milk fat levels require a centrifuge or HPLC (Menjo et al. Acta Paediatrica (2009) 98: 380) and therefore are often too expensive and bulky to employ in a home or field setting.

As discussed above, milk lipids are effective surfactants that lower the surface tension from 47.3±1.2 mN/m for low calorie (skim) milk to 41.9±1.1 mN/m for high calorie (whole) milk. Using a surface tension sensor according to one embodiment described herein (e.g., the one used in Example 3 that wets at 45.0 mN/m but remains non-wetted at 48.0 mM/m), a plot of the calorie content as a function of time and food intake can be obtained, which enables a mother to identify the best time to feed her newborn to ensure an adequate amount or even a high amount of fat or calorie content in her breast milk. By doing so, newborns can receive the calories that are needed for proper development. In some embodiments, the surface tension sensor, device and/or kit described herein can be useful for mothers in the feeding of infants and newborns who are of low birth-weight or are not gaining sufficient weight as a function of time. In these embodiments, the kit can also contain a logbook and/or chart and/or website address where the mother may record her caloric history. This can enable mothers to keep track of such variables as the historical readings, the time of day, time since last meal, and/or meal portion and type. Thus, information can be retrieved allowing the mother to make informed decision on when is the best time to breastfeed to obtain optimal caloric nutrition for the infant. The logbook, chart, or web database can allow the mother to privately maintain this information.

### Example 7

### Exemplary Methods that were Used in Examples 1-5

Polymer Synthesis and Characterization

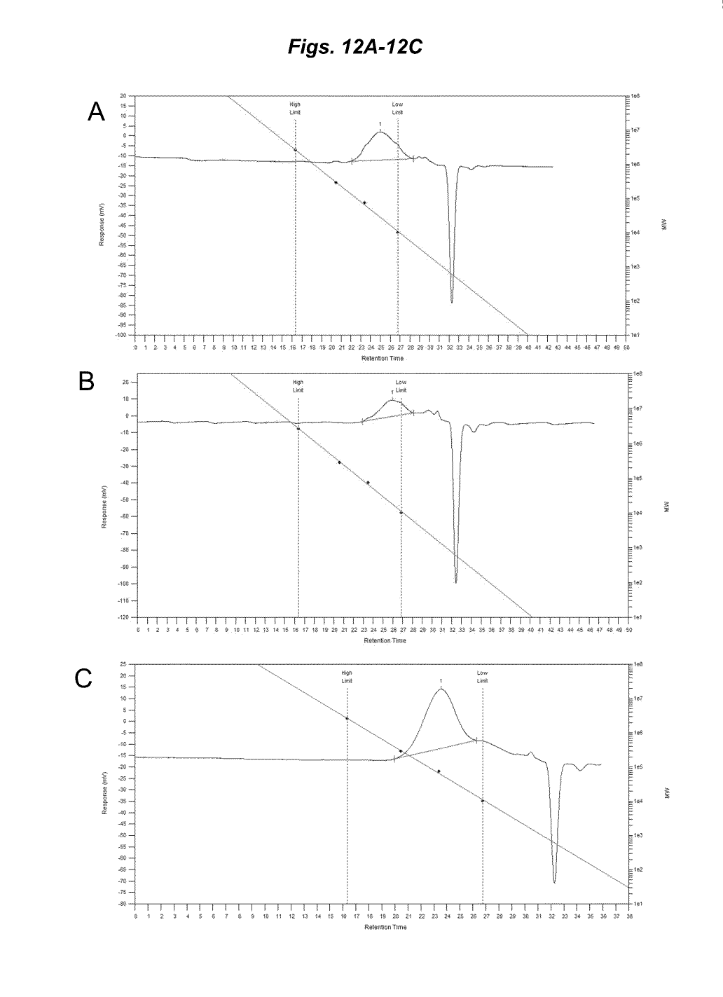

To prepare the sensor mesh, e.g., as described in Examples 1-5, PCL can be purchased (Sigma, 70-90 kDa) while PGC-C18 and PGC-OH can be synthesized following a protocol as described in Wolinsky et al., Macromolecules (2007) 40:7065-7068, with the exception that the 5-benzyloxy-1,3-dioxan-2-one and ε-caprolactone monomers are polymerized at a molar ratio of 1:20 for the dopants in the selectively wetting layer or responsive wetting layer, as shown in FIG. 11. This lower ratio can reduce the hydrophobicity or hydrophilicity of the dopant to allow for more reliable tuning in the desired ranges. The PGC-OH in the indicator layer did not need such mild hydrophilicity, so the monomer ratio for that polymer was 1:4. By GPC compared to polystyrene standards, PGC-C18 has MW of 31.3 kDa and dispersity of 1.47, the PGC-OH (1:20) has MW of 22.9 kDa and dispersity of 1.32, and the PGC-OH (1:4) has MW of 76.0 kDa and a dispersity of 1.36, as shown in FIGS. 12A-12C.

Electrospinning

All polymer solutions are electrospun at 140, 150, or 175 mg/mL of the polymer mixture in chloroform:methanol (5:1). For the meshes described in the Examples, the indicator layer included the same component, 85 or 90% PCL with 5 or 10% PGC-OH by weight with 5% bromocresol purple (BCP), a pH indicator dissolved at 150 mg/mL. In one embodiment, the milk sensor responsive wetting layer or selectively wetting layer is 7.5% PGC-C18 and 92.5% PCL by weight. In one embodiment, the urine sensor responsive wetting layer or selectively wetting layer is 5% PGC-C18 and 95% PCL.

To electrospin, the responsive wetting/selectively wetting and indicator solutions (for making the responsive wetting layer or selectively wetting layer and the indicator layer, respectively) are pumped through 20G needles at 5 ml/hr while voltages from 13-18 kV are applied. In some embodiments, the responsive/selectively wetting and indicator solutions can be electrospinned simultaneously to form the majority portion of the sensor with a responsive wetting layer or selectively wetting layer formed on top as the fluid-contacting surface. In other embodiments, the indicator solution alone can be subjected to electrospinning first (e.g., for the first 5 minutes) to form the indicator layer, then the voltage and flow to the indicator needle is stopped, and the responsive wetting layer or selectively wetting layer alone is electrospun for a pre-determined period of time: e.g., about 5 minutes for the milk sensor mesh and about 2 minutes for the urine sensor mesh. To illustrate the differences in fibers from these two solutions, for the mesh shown in FIG. 8, the indicator layer was electrospun alone, followed by the responsive wetting layer or selectively wetting layer on top, but meshes can be more mechanically robust when the responsive wetting/selectively wetting solution is electrospun throughout.

TABLE 1
Example electrospinning conditions and compositions for sensor meshes, and the
resulting detection ranges

| | | Indicator | | | | |
|---|---|---|---|---|---|---|
| | | layer co-spun | | Selectively | Selectively | |
| | | with | | wetting | wetting | |
| | | selectively | Selectively wetting | layer | layer | |
| | | wetting layer | layer (responsive | (responsive | (responsive | |
| | Indicator | (responsive | wetting layer) | wetting | wetting | Mean detection |
| | layer time, | wetting | solution, | layer) time, | layer) fiber | range |
| | flow rates | layer)? | composition | flow rates | diameter | (5 min-0.5 min) |
| Milk Sensor | 5% PGC-OH | Yes | 150 mg/mL, | 5.0 mL/hr, | 6.0 ± 1.4 μm | 49-45 mN/m |
| | (1:4), 5% | | 7.5% PGC-C18 | 5.0 min | | |
| | BCP | | (1:20) | | | |
| Urine Sensor | 5% PGC-OH | Yes | 140 mg/mL, | 5.0 mL/hr, | 1.6 ± 0.7 μm | 53-50 mN/m |
| | (1:4), 5% | | 5.0% PGC-C18 | 2.0 min | | |
| | BCP | | (1:20) | | | |
| Layering | 10% PGC- | No | 140 mg/mL | 5.0 mL/hr, | 1.5 ± 0.6 μm | 63.5-57.5 mN/m |
| demonstration | OH (1:4), 5% | | 5.0% PGC-C18 | 1.5 min | | |
| | BCP | | (1:20) | | | |
| Water Sensor | 10% PGC- | No | 175 mg/mL, | 7.5 mL/hr, | 3.5 ± 0.2 μm | 63.5-61.5 mN/m |
| | OH (1:4), 1% | | 7.5% PGC-OH | 4.0 min | | |
| | BCP | | (1:20) | | | |

As shown in FIGS. 13A-13B, meshes which have the responsive wetting or selectively wetting solution co-spun throughout the indicator layer have a less clearly defined layered structure, but are mechanically robust enough to be peeled off the substrate surface (e.g., aluminum foil) onto which they were electrospun, unlike the mesh shown in FIG. 8 with two distinct layers. Additionally, the morphology of the water sensor mesh is shown in FIG. 14, which is also not co-spun but has a responsive wetting layer or selectively wetting layer that is too thick to see through to the indicator layer from the top.

Predicted Specificity and Sensitivity

Given the distribution of surface tension between whole and skim milks and the ability to resolve differences between surface tensions by observing wetting times, sensors of different sensitivity and specificity can be predicted. This is done by creating a receiver-operating characteristic (ROC) curve at each end of the CWST range, then combining the two using the minimum values which result. For example, the CWST range 48-45 mN/m has a sensitivity of 0.2798 and a specificity of 0.998 in differentiating the two populations: the normal milk at 41.9±1.1 mN/m and skim milk at 47.3±1.2 mN/m. The sensitivity is the true positive rate, i.e. the expected rate of abnormally low surface tension samples correctly identified as such. In this case sensitivity can be found by calculating the fraction of the normal distribution 47.3±1.2 mN/m that is greater than 48 mN/m, which is 0.2798.

The specificity is the true negative rate, i.e. the expected rate of normal surface tension samples that are correctly identified. In this case specificity can be found by calculating the fraction of the normal distribution 41.9±1.1 mN/m that is less than 45 mN/m, which is 0.998.

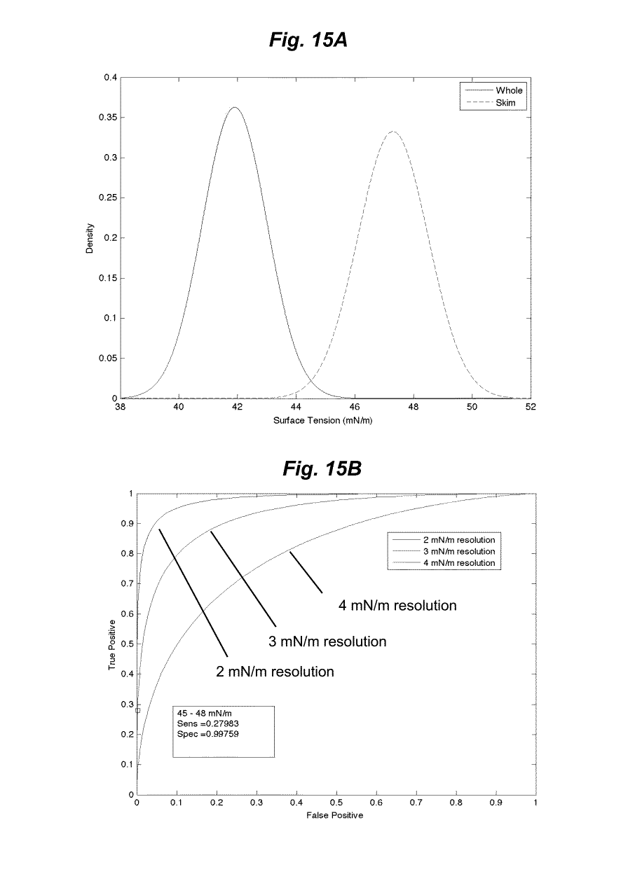

The milk mesh characterized in the Examples here was designed for high specificity (at the cost of sensitivity), though as shown in FIGS. 15A-15B, this can be tuned as desired.

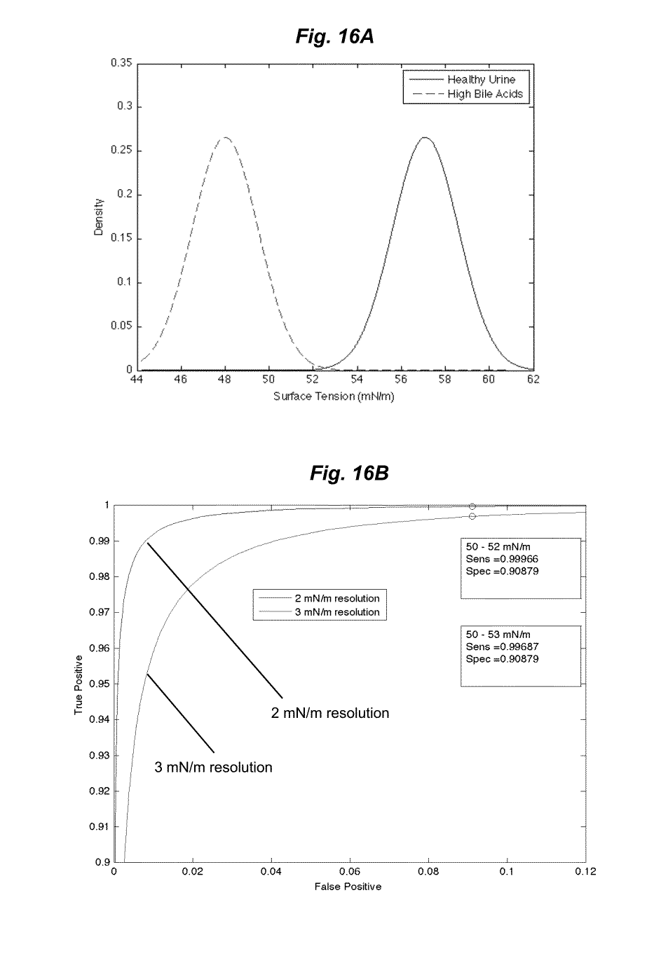

Similarly, the sensitivity and specificity of the urine sensors can be predicted. By extrapolating the bile acid concentration from Mills et al. (J. Clin. Chem. Biochem. (1988) 26: 187) to the 20 μM range indicated by Trottier (PloS One (2011) 6: e22094), the surface tension of a urine sample with elevated bile acids can be determined with a mean of 48 mN/m and assuming the same standard deviation as the normal level (Thomas et al. J. Adhes. Sci. Tech. (2009) 23: 1917) at 57.1±1.5 mN/m. FIGS. 15A-16B show two distributions and the resulting ROC curves for different surface tension sensor resolutions, as well as the point for the urine sensor characterized herein. For example, the CWST range 52-50 mN/m has a sensitivity of 0.9997 and a specificity of 0.9088 in differentiating the two populations: the normal 57.1±1.5 mN/m and abnormal at 48±1.5 mN/m. The sensitivity is the true positive rate, i.e. the expected rate of abnormally low surface tension samples correctly identified as such. In this case sensitivity can be found by calculating the fraction of the normal distribution 57.1±1.5 mN/m which is greater than 52 mN/m, which is 0.9997.

The specificity is the true negative rate, i.e. the expected rate of normal surface tension samples that are correctly identified. In this case specificity can be found by calculating the fraction of the normal distribution 48±1.5 mN/m which is less than 50 mN/m, which is 0.9088.

Urine Sensor Testing

To create models of diseased and normal urine, the bile acid deoxycholic acid is added to pooled normal human urine (Innovative Research, Novi, Mich.) until the surface tensions as measured by the pendant drop method are 50 and 54 mN/m, which requires concentrations of 240 and 96 μM, respectively. Using a camera mounted overhead (Nikon D3200) with fixed manual settings, photos of the droplets are taken every 5 seconds, as shown in FIG. 9B and FIG. 10E. Additional analysis of these photos using ImageJ quantifies the mean brightness of fixed areas in each droplet (a circle of 1.70 mm² in each, nearly the entire droplet) over time, as shown in FIG. 10F.

As shown in FIG. 10F, the urine droplet with lower surface tension rapidly gets darker on the mesh sensor from the dissolving indicator dye while the droplet of higher surface tension remains clear. This is a quantification of the overhead images shown in FIG. 10E.

Milk Testing

To create models of diseased and normal breast milk, normal human breast milk (Innovative Research) is compared to breast milk that was diluted 1:2 in distilled water on the left. The diluted milk remained non-wetting for at least over 2.5 minutes or longer (e.g., over 3 minutes), but the whole milk was absorbed within 1.5 minutes. Screen captures are shown in FIG. 9B.

### Example 8

### Use of the Surface Tension Sensor to Obtain Alcoholic Content

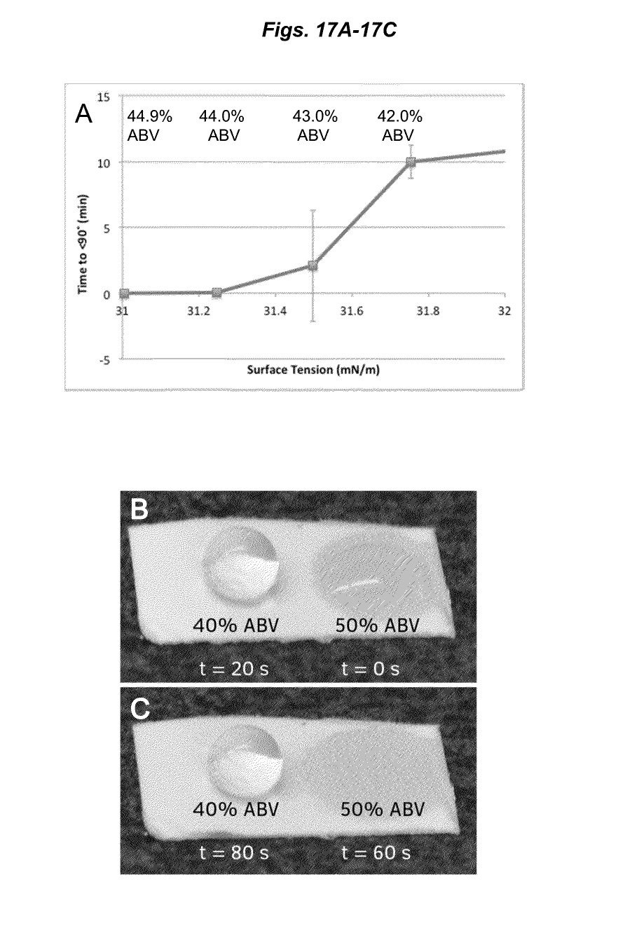

Alcoholic content in wine can affect surface tension. Glampedaki et al., J. Food Comp. Anal. (2010) 23: 373-381. In industrial production or home-scale production of wine, beer, or alcoholic spirits, the surface tension sensors could be used to determine the alcoholic content. A sensor was created with 50% PGC-18 (1:4), 50% PCL in the selectively wetting layer, electrospun at 160 mg/mL at 3 mL/hr for 10 minutes. As shown in FIGS. 17A-17C, variations of 1-2% alcohol by volume (ABV) of water-ethanol solutions are enough to be resolvable by the sensors according to one or more embodiments described herein. In this example, the “slow wetting” time can be any time greater than 2 minutes would indicate an alcohol content of 44% or less, and the “fast wetting” time can be 5 seconds or less.

### REFERENCES

The cited references and publications in the specification and Examples section are incorporated herein in their entirety by reference.
(1) Handbook of Applied Surface and Colloid Chemistry; Holmberg, K.; Shah, D. O.; Schwuger, M. J., Eds.; John Wiley & Sons: Baffins Lane, Chichester, West Sussex PO19 1UD, England, 2002; Vol. 2, pp. 1-500.
(2) Erbil, H. Y.; Cansoy, C. E. Langmuir 2009, 25, 14135-14145.
(3) Koishi, T.; Yasuoka, K.; Fujikawa, S.; Ebisuzaki, T.; Zeng, X. C. Proc. Natl. Acad. Sci. U.S.A. 2009, 106, 8435-8440.
(4) Marmur, A. Soft Matter 2013, 9, 7900.
(5) Genzer, J.; Efimenko, K. Biofouling 2006, 22, 339-360.
(6) Sakai, M.; Nakajima, A. Chem. Lett. 2010, 39, 482.
(7) Enright, R.; Miljkovic, N.; Al-Obeidi, A.; Thompson, C. V.; Wang, E. N. Langmuir 2012, 28, 14424-14432.
(8) Manna, U.; Kratochvil, M. J.; Lynn, D. M. Adv. Mater. 2013, 25, 6405-6409.
(9) Yohe, S. T.; Colson, Y. L.; Grinstaff, M. W. J. Am. Chem. Soc. 2012, 134, 2016-2019.
(10) Bormashenko, E.; Musin, A.; Whyman, G.; Zinigrad, M. Langmuir 2012, 28, 3460-3464.
(11) Murakami, D.; Jinnai, H.; Takahara, A. Langmuir 2014, 30, 2061-2067.
(12) Sharma, P.; Rao, K. H. Adv. Colloid Interface Sci. 2002, 98, 341-463.
(13) Martinez, A. W.; Phillips, S. T.; Nie, Z.; Cheng, C.-M.; Carrilho, E.; Wiley, B. J.; Whitesides, G. M. Lab Chip 2010, 10, 2499-2504.
(14) Nie, Z.; Nijhuis, C. A.; Gong, J.; Chen, X.; Kumachev, A.; Martinez, A. W.; Narovlyansky, M.; Whitesides, G. M. Lab Chip 2010, 10, 477-483.
(15) Xing, S.; Harake, R. S.; Pan, T. Lab Chip 2011, 11, 3642.
(16) Elsharkawy, M.; Schutzius, T. M.; Megaridis, C. M. Lab Chip 2014, 14, 1168-1175.
(17) Li, L.; Tian, J.; Li, M.; Shen, W. Colloids Surf. B 2013, 106, 176-180.
(18) Gentile, F.; Coluccio, M. L.; Coppedè, N.; Mecarini, F.; Das, G.; Liberale, C.; Tirinato, L.; Leoncini, M.; Perozziello, G.; Candeloro, P.; De Angelis, F.; Di Fabrizio, E. ACS Appl. Mater. Interfaces 2012, 4, 3213-3224.
(19) Ebrahimi, A.; Dak, P.; Salm, E.; Dash, S.; Garimella, S. V.; Bashir, R.; Alam, M. A. Lab Chip 2013, 13, 4248-4256.
(20) Zhang, Y.; Wang, H.; Li, J.; Nie, J.; Zhang, Y.; Shen, G.; Yu, R. Biosens. Bioelectron. 2011, 26, 3272-3277.
(21) Huang, C. J.; Fang, W. F.; Ke, M. S.; Chou, H. Y. E.; Yang, J. T. Lab Chip 2014, 14, 2057-2062.
(22) Azzaroni, O.; Brown, A. A.; Huck, W. T. S. Adv. Mater. 2007, 19, 151-154.
(23) Wang, L.; Peng, B.; Su, Z. Langmuir 2010, 26, 12203-12208.
(24) Feng, N.; Zhao, H.; Zhan, J.; Tian, D.; Li, H. Org. Lett. 2012, 14, 1958-1961.
(25) Lee, C. H.; Kang, S. K.; Lim, J. A.; Lim, H. S.; Cho, J. H. Soft Matter 2012, 8, 10238.
(26) Sun, W.; Zhou, S.; You, B.; Wu, L. J. Mater. Chem. A 2013, 1, 3146.
(27) U.S. Department of Health and Human Services. The Surgeon General's Call to Action to Support Breastfeeding; U.S. Department of Health and Human Services, Office of the Surgeon General: Washington D.C., 2011; pp. 1-100.
(28) Centers for Disease Control and Prevention. Breastfeeding Among U.S. Children Born 2000-2010, CDC National Immunization Survey http://www.cdc.gov/breastfeeding/data/NIS_data/index.htm (accessed Mar. 25, 2014).
(29) Li, R.; Fein, S. B.; Chen, J.; Grummer-Strawn, L. M. Pediatrics 2008, 122, S69-S76.
(30) Meier, P. P.; Engstrom, J. L.; Zuleger, J. L.; Motykowski, J. E.; Vasan, U.; Meier, W. A.; Hartmann, P. E.; Williams, T. M. Breastfeed. Med. 2006, 1, 79-87.
(31) Kristensen, D.; Jensen, P. Y.; Madsen, F.; Birdi, K. S. J. Dairy Sci. 1997, 80, 2282-2290.
(32) Thomas, E. A.; Poritz, D. H.; Muirhead, D. L. J. Adhes. Sci. Tech. 2009, 23, 1917-1923.
(33) Mills, C. O.; Ellas, E.; Martin, G. H. B.; Woo, M. T. C.; Winder, A. F. J. Clin. Chem. Biochem. 1988, 26, 187-194.
(34) Trottier, J.; Bia [symbol] ek, A.; Caron, P.; Straka, R. J.; Milkiewicz, P.; Barbier, O. PloS One 2011, 6, e22094.
(35) Yousef, I. M.; Perwaiz, S.; Lamireau, T.; Tuchweber, B. Med. Sci. Monit. 2003, 9, MT21-MT31.
(36) Diskin, C. J.; Stokes, T. J.; Dansby, L. M.; Carter, T. B.; Radcliff, L. Lancet 2000, 355, 901-902.
(37) Kratochvil, A.; Hrn\check{c}í\check{r}, E. Physiol. Res. 2001, 50, 433-437.
(38) Kazakov, V. N.; Sinyachenko, O. V.; Fainerman, B.; Pison, U.; Miller, R. Dynamic Surface Tensiometry in Medicine; Möbius, D.; Miller, R., Eds.; Elsevier Science: Amsterdam, Netherlands, 2000; Vol. 8.
(39) Esitashvili, T. A.; Msuknishvili, M. Washington D.C., 2002; pp. 1-1.
(40) Rosen, M. J.; Zhu, Y.-P.; Morrall, S. W. J. Chem. Eng. Data 1996, 41, 1160-1167.
(41) Fauvart, M.; Phillips, P.; Bachaspatimayum, D.; Verstraeten, N.; Fransaer, J.; Michiels, J.; Vermant, J. Soft Matter 2012, 8, 70-76.
(42) Chaudhury, M. K.; Whitesides, G. M. Science 1992, 256, 1539-1541.
(43) A. W. Martinez, S. T. Phillips, G. M. Whitesides, and E. Carrilho, Anal. Chem., 2010, 82, 3-10.
(44) X. Mao and T. J. Huang, Lab Chip, 2012, 12, 1412-1416.
(45) A. K. Yetisen, M. S. Akram, and C. R. Lowe, Lab Chip, 2013, 13, 2210-2251.
(46) D. N. Breslauer, R. N. Maamari, N. A. Switz, W. A. Lam, and D. A. Fletcher, PloS One, 2009, 4, e6320.
(47) A. Skandarajah, C. D. Reber, N. A. Switz, and D. A. Fletcher, PloS One, 2014, 9, e96906.
(48) Y. Xiang and Y. Lu, Nat. Chem., 2011, 3, 697-703.
(49) E. A. Thomas, D. H. Poritz, and D. L. Muirhead, J. Adhes. Sci. Tech., 2009, 23, 1917-1923.
(50) C. O. Mills, E. Ellas, G. H. B. Martin, M. T. C. Woo, and A. F. Winder, J. Clin. Chem. Biochem., 1988, 26, 187-194.
(51) J. Trottier, A. Bia [symbol] ek, P. Caron, R. J. Straka, P. Milkiewicz, and O. Barbier, PloS One, 2011, 6, e22094.
(52) I. M. Yousef, S. Perwaiz, T. Lamireau, and B. Tuchweber, Med. Sci. Monit., 2003, 9, MT21-31.
(53) C. J. Diskin, T. J. Stokes, L. M. Dansby, T. B. Carter, and L. Radcliff, Lancet, 2000, 355, 901-902.
(54) J. B. Wolinsky, W. C. Ray III, Y. L. Colson, and M. W. Grinstaff, Macromolecules, 2007, 40, 7065-7068.
(55) Grinstaff, J. Control. Release, 2010, 144, 280-287.
(56) B. C. Hoke Jr and E. F. Patton, J. Chem. Eng. Data, 1992, 37, 331-333.
(57) J. Bico, C. Marzolin, and D. Quéré, Europhys. Lett., 1999, 1-7.
(58) A. Lafuma and D. Quéré, Nature Mater., 2003, 2, 457-460.
(59) F. Buatier De Mongeot, D. Chiappe, F. Gagliardi, A. Toma, R. Felici, A. Garibbo, and C. Boragno, Soft Matter, 2010, 6, 1409
(60) U.S. Department of Health and Human Services, The Surgeon General's Call to Action to Support Breastfeeding, U.S. Department of Health and Human Services, Office of the Surgeon General, Washington D.C., 2011.
(61) Centers for Disease Control and Prevention, Breastfeeding Report Card 2013, Centers for Disease Control and Prevention, 2013.
(62) R. Li, S. B. Fein, J. Chen, and L. M. Grummer-Strawn, Pediatrics, 2008, 122, S69-S76.
(63) Wenzel, R. N. Ind. Eng. Chem. 1936, 28, 988-994
(64) Cassie, A. B. D.; Baxter, S.; Tram. Faraday Soc. 1944, 40, 546-551
(65) A. Tuteja, W. Choi, J. M. Mabry, G. H. McKinley, R. E. Cohen, Proc. Natl. Acad. Sci. U.S.A., 2008, 18200-18205
(66) Houska, M. (1994). Milk, Milk Products and Semiproducts: Thermophysical and Rheological Properties of Foods. Prague: Institute of Agricultural and Food Information.
(67) J. B. Wolinsky, R. Liu, J. Walpole, L. R. Chirieac, Y. L. Colson, M. W. Grinstaff, J. Control. Release. 144 (2010) 280-287.
(68) A. Lee, H. Jin, H.-W. Dang, K.-H. Choi, K. H. Ahn, Langmuir. 29 (2013) 13630-13639.
(69) A. H. Ellison, W. A. Zisman, J. Phys. Chem. 58 (1954) 503-506.

Throughout this application, various publications are referenced. The disclosures of all of the publications and those references cited within those publications in their entireties are hereby incorporated by reference into this application in order to more fully describe the state of the art to which this invention pertains.

What is claimed is:

1. A method of determining surface tension of a fluid sample comprising:
a. contacting the fluid sample with a selectively wetting layer of a surface tension sensor, wherein the surface tension sensor comprises the selectively wetting layer and an indicator layer, the selectively wetting layer comprising a roughened and/or porous structure tuned to a pre-determined critical wetting surface tension (CWST), and the indicator layer comprising a hydrophilic material and a detectable agent, wherein the detectable agent generates a detectable signal upon wetting of the indicator layer;
b. detecting a detectable signal from the indicator layer; and
c. determining surface tension of the fluid sample to be below the pre-determined CWST if a detectable signal from the indicator layer is present; or
determining surface tension of the fluid sample to be at or above the pre-determined CWST if a detectable signal from the indicator layer is absent.

2. The method of claim 1, wherein the selectively wetting layer comprises microfibers.

3. The method of claim 2, wherein the microfibers have a diameter of about 1 μm to about 10 μm.

4. The method of claim 1, wherein the pre-determined CWST is characterized by a non-wetted or partially wetted state to a wetted state within a range of about 1-2 mN/m, 2-3 mN/m, or 3-4 mN/m.

5. The method of claim 1, wherein the predetermined CWST is between 25 and 30 mN/m, between 30 and 35 mN/m, between 35 and 40 mN/m, between 40 and 45 mN/m, between 45 and 50 mN/m, between 50 and 55 mN/m, between 55 and 60 mN/m, between 60 and 65 mN/m, between 65 and 70 mN/m, or between 70 and 75 mN/m.

6. The method of claim 1, wherein the roughened and/or porous structure is generated by a process comprising soft lithography, hard lithography, reactive ion etching, acid etching, salt leaching, freeze drying, spray drying, gas foaming, electrospraying, electrospinning, weaving, pressing pulp, polyelectrolyte multilayer assembly, or any combinations thereof.

7. The method of claim 1, wherein the roughened and/or porous structure or the hydrophilic material comprises at least one polymer selected from the group consisting of Teflon, polystyrene, modified polystyrene, polypropylene, polyurethane, ethylene vinyl alcohol, (E/VAL), cellulose, lignocellulose, fluoroplastics, (PTFE), (FEP, PFA, CTFE, ECTFE, ETFE), fluorosilanes, polyacrylates, (Acrylic), polybutadiene, (PBD), polybutylene, (PB), polydimethylsioxane (PDMS), poly(ε-caprolactone) (PCL), poly(glycerol-co-ε-caprolactone) (PGC-OH), poly(glycerol monostearate-co-ε-caprolactone), (PGC-C18), polyethylene, (PE), polyethylenechlorinates, (PEC), polylactide, (PLA), poly(lactic-co-glycolic acid), (PLGA), poly(lactic acid-co-glycerol monostearate), (PLA-PGC₁₈), polymethylpentene, (PMP), polypropylene, (PP), polyvinylchloride, (PVC), polyvinylidene chloride, (PVDC), acrylonitrile butadiene styrene, (ABS), Polyamide, (PA), (Nylon), polyamide-imide, (PAI), polyaryletherketone, (PAEK), (Ketone), polycarbonate, (PC), Polyektone, (PK), polyester, polyetheretherketone, (PEEK), polyetherimide, (PEI), polyethersulfone, (PES), polyimide, (PI), polyphenylene oxide, (PPO), polyphenylene sulfide, (PPS), polyphthalamide, (PTA), polysulfone, (PSU), allyl resin, (Allyl), melamine formaldehyde, (MF), phenol-formaldehyde plastic, (PF), polyester, polyimide (PI), silicone, silicon, silicon nitride, and any combinations thereof.

8. The method of claim 1, wherein the detectable agent is selected from the group consisting of litmus, bromophenol blue, bromophenol red, cresol red, α-naphtholphthalein, methyl purple, thymol blue, methyl yellow, methyl orange, methyl red, bromcresol purple, bromocresol green, chlorophenol red, bromothymol blue, phenol red, cresol purple, Creosol red, thymol blue, phenolphthalein, thymolphthalein, indigo carmine, alizarin yellow R, alizarin red S, pentamethoxy red, tropeolin O, tropeolin OO, tropeolin OOO, 2,4-dinitrophenol, tetrabromophenol blue, Neutral red, Chlorophenol red, 4-Nitrophenol, p-Xylenol blue, Indigo carmine, p-Xylenol blue, Eosin, bluish, Epsilon blue, Bromothymol blue, Thymolphthalein, Titan yellow, Alkali blue, 3-Nitrophenol, Bromoxylenol blue, Crystal violet, Cresol red, Congo red, Bromophenol blue, Quinaldine red, 2,4-Dinitro phenol, 2,5-Dinitrophenol, 4-(Dimethylamino) azobenzol, Bromochlorophenol blue, Malachite green oxalate, Brilliant green, alizarin sodium sulfonate, Eosin yellow, Erythrosine B, α-naphthyl red, p-ethoxychrysoidine, p-nitrophenol, azolitmin, neutral red, rosolic acid, α-naphtholbenzein, Nile blue, salicyl yellow, diazo violet, nitramine, Poirrier's blue, trinitrobenzoic acid, Congo red, Azolitmin, Neutral red, Nile red, Cresol Red, Alizarine Yellow R and salts thereof, and any combinations thereof.

9. The method of claim 1, wherein the fluid sample has a volume of about 1 μL-5 μL, or about 1 μL-10 μL.

10. The method of claim 1, further comprising allowing the contact of the fluid sample with the selectively wetting layer for between 1 minute and 15 minutes, prior to said detecting step.

11. The method of claim 1, wherein the fluid sample is selected from the group consisting of water, food products (e.g., milk, wine, beer, alcoholic spirits), bodily fluid (e.g., blood, urine, saliva, tears, lymph fluid, cerebrospinal fluid), breast milk, infant formula, and any combinations thereof.

12. The method of claim 1, further comprising identifying condition or status of the fluid sample based on the determined surface tension of the fluid sample.

13. The method of claim 1, wherein the method is used to distinguish a first fluid sample from a second fluid sample by performing the method with the first fluid sample and the second fluid sample simultaneously or sequentially.

14. The method of claim 13, wherein the surfactant level in the first fluid and the second fluid are different.

15. A portable device comprising a solid substrate surface and at least one surface tension sensor disposed thereon, wherein said at least one surface tension sensor comprises a selectively wetting layer and an indicator layer, the selectively wetting layer comprising a roughened and/or porous material tuned to a pre-determined critical wetting surface tension (CWST), and the indicator layer comprising a hydrophilic material and a detectable agent, wherein the detectable agent generates a detectable signal upon wetting of the indicator layer.

16. The portable device of claim 15, further comprising at least one control sensor disposed on the solid substrate surface, wherein the control sensor generates a reference signal.

17. The portable device of claim 15, wherein at least two surface tension sensors are disposed on the solid substrate surface.

18. The portable device of claim 17, wherein the pre-determined CWST of said at least two surface tension sensors differs from each other.

19. The portable device of claim 17, wherein the pre-determined CWST of said at least two surface tension sensors are the same.

20. The portable device of claim 15, wherein the solid substrate surface comprises cellulose, paper, glass, and/or polymer.
